(19) United States
(12) Patent Application Publication
(10) Pub. No.: US 2026/0270425 A1
(43) Pub. Date: Sep. 10, 2026

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Yaojun WU, Beijing (CN); Semih ESENLIK, Los Angeles, CA (US); Zhaobin ZHANG, Los Angeles, CA (US); Meng WANG, Beijing (CN); Kai ZHANG, Los Angeles, CA (US); Li ZHANG, Los Angeles, CA (US)

(21) Appl. No.: 19/656,808

(22) Filed: Apr. 23, 2026

Related U.S. Application Data
(63) Continuation of application No. PCT/CN2024/126423, filed on Oct. 22, 2024.

(30) Foreign Application Priority Data
Oct. 23, 2023 (WO) PCT/CN2023/126016

(51) Int. Cl. H04N 19/119; H04N 19/117; H04N 19/70; H04N 19/80

(52) U.S. Cl. CPC H04N 19/119; H04N 19/117; H04N 19/70; H04N 19/80

(57) ABSTRACT

A solution for visual data processing is provided. A method for visual data processing is proposed. The method comprises: partitioning, for a conversion between visual data and a bitstream of the visual data with a neural network (NN)-based model, a first tensor used in an adaptive filter of the NN-based model into a first set of tiles based on a first tile size, the first tile size being a multiple of a first predetermined value; and performing the conversion based on the first set of tiles.

### CROSS REFERENCE TO RELATED APPLICATIONS

This application is a continuation of International Application No. PCT/CN2024/126423, filed on Oct. 22, 2024, which claims the benefit of International Application No. PCT/CN2023/126016, filed on Oct. 23, 2023. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding efficiency of neural network-based image/video coding is generally expected to be further improved.

### SUMMARY

Embodiments of the present disclosure provide a solution for visual data processing.

In a first aspect, a method for visual data processing is proposed. The method comprises: partitioning, for a conversion between visual data and a bitstream of the visual data with a neural network (NN)-based model, a first tensor used in an adaptive filter of the NN-based model into a first set of tiles based on a first tile size, the first tile size being a multiple of a first predetermined value; and performing the conversion based on the first set of tiles.

Based on the method in accordance with the first aspect of the present disclosure, the first tensor used in an adaptive filter of the NN-based model is partitioned into a first set of tiles based on a first tile size, and the first tile size is a multiple of a first predetermined value. Compared with the conventional solution where the size of the tile is not limited, the proposed method can advantageously ensure that the size of most of tiles is a multiple of a predetermined value. Thereby, the coding efficiency can be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: partitioning a first tensor used in an adaptive filter of a neural network (NN)-based model into a first set of tiles based on a first tile size, the first tile size being a multiple of a first predetermined value; and generating the bitstream with the NN-based model based on the first set of tiles.

In a fifth aspect, a method for storing a bitstream of visual data is proposed. The method comprises: partitioning a first tensor used in an adaptive filter of a neural network (NN)-based model into a first set of tiles based on a first tile size, the first tile size being a multiple of a first predetermined value; generating the bitstream with the NN-based model based on the first set of tiles; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1A illustrates a block diagram that illustrates an example visual data coding system, in accordance with some embodiments of the present disclosure;

FIG. 1B is a schematic diagram illustrating an example transform coding scheme;

FIG. 2 illustrates example latent representations of an image;

FIG. 3 is a schematic diagram illustrating an example autoencoder implementing a hyperprior model;

FIG. 4 is a schematic diagram illustrating an example combined model configured to jointly optimize a context model along with a hyperprior and the autoencoder;

FIG. 5 illustrates an example encoding process;

FIG. 6 illustrates an example decoding process;

FIG. 7 illustrates an example decoding process according to some embodiments of the present disclosure;

FIG. 8 illustrates an example learning-based image codec architecture;

FIG. 9 illustrates enhancement filter technologies;

FIG. 10 illustrates an example implementation of primary component guided adaptive up-sampling filter;

FIG. 11 illustrates an example implementation of EFE non-linear filter;

FIG. 12 illustrates an example implementation of the simplified EFE non-linear filter;

FIG. 13 illustrates an example implementation of quantized primary component guided adaptive up-sampling filter;

FIG. 14 illustrates an example implementation of quantized EFE non-linear filter;

FIG. 15 illustrates an example implementation of simplified primary component guided adaptive up-sampling filter;

FIG. 16 illustrates an example implementation of simplified EFE non-linear filter;

FIG. 17 illustrates a flowchart of a method for visual data processing in accordance with embodiments of the present disclosure; and

FIG. 18 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

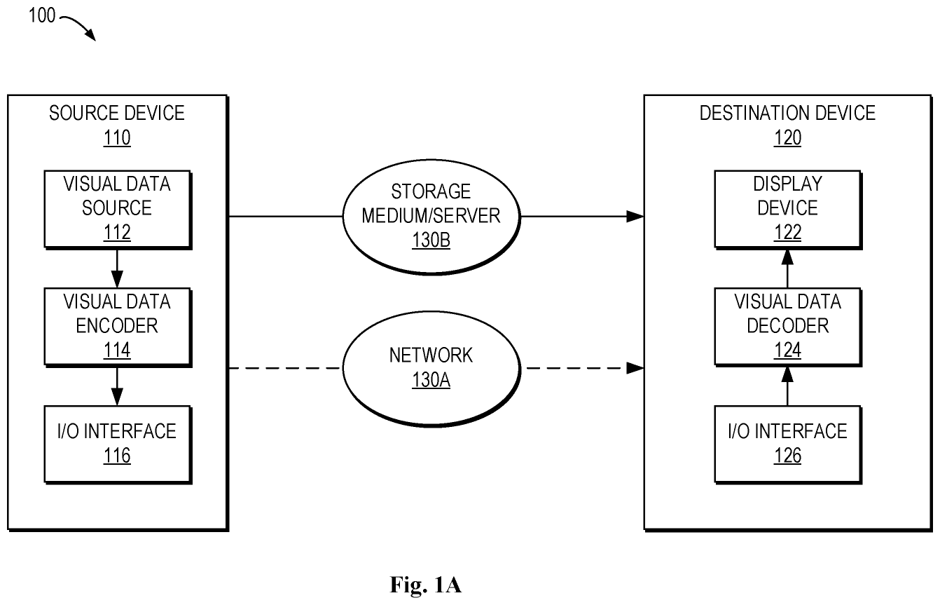

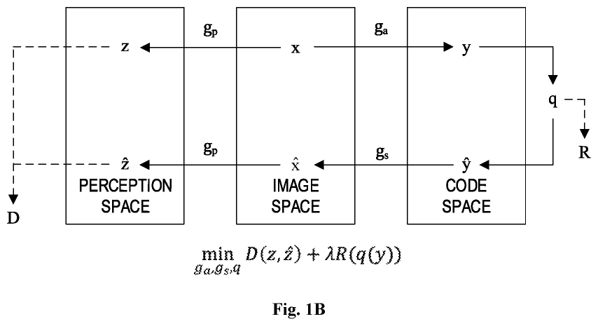

FIG. 1A is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter.

The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter.

It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1 BRIEF SUMMARY

This disclosure is related to neural network (NN)-based image and video coding. Specifically, it is related to improvements of the enhancement filter.

### 2 INTRODUCTION

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from MPEG and VCEG.

With the performance of neural image compression continually being improved, neural network-based video compression has become an actively developing research area. However, neural network-based video coding still remains in its infancy due to the inherent difficulty of the problem.

### 2.1 Image/Video Compression

Image/video compression (also referred to as image/video coding) usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new invention since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 2.2 Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3 Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1 Pixel Probability Modeling

According to Shannon's information theory, the optimal method for lossless coding can reach the minimal coding rate −log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit −log₂ p(x) without considering the rounding error. Therefore, the remaining problem is to how to determine the probability, which is however very challenging for natural image/video due to the curse of dimensionality.

Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p(xᵢ) given its context x₁, x₂, . . . , xᵢ₋₁.

Most of the methods directly model the probability distribution in the pixel domain. Some researchers also attempt to model the probability distribution as a conditional one upon explicit or latent representations. That being said, we may estimate

$$p ( x \vert h ) = {\prod }_{i = 1}^{m \times n} p ( {x}_{i} \vert {x}_{1} , ... , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2 Auto-Encoder

Auto-encoder originates from the well-known work proposed by Hinton and Salakhutdinov. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

FIG. 1B illustrates a typical transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image R. The distortion is calculated in a perceptual space by transforming x and \hat{x} with the function gₚ.

It is intuitive to apply auto-encoder network to lossy image compression. We only need to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 1B, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., [symbol] =D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

### 2.3.3 Hyper Prior Model

In the transform coding approach to image compression, the encoder subnetwork (section 2.3.2) transforms the image vector x using a parametric analysis transform gₐ(x, ø_{g}) into a latent representation y, which is then quantized to form ŷ. Because ŷ is discrete-valued, it can be losslessly compressed using entropy coding techniques such as arithmetic coding and transmitted as a sequence of bits.

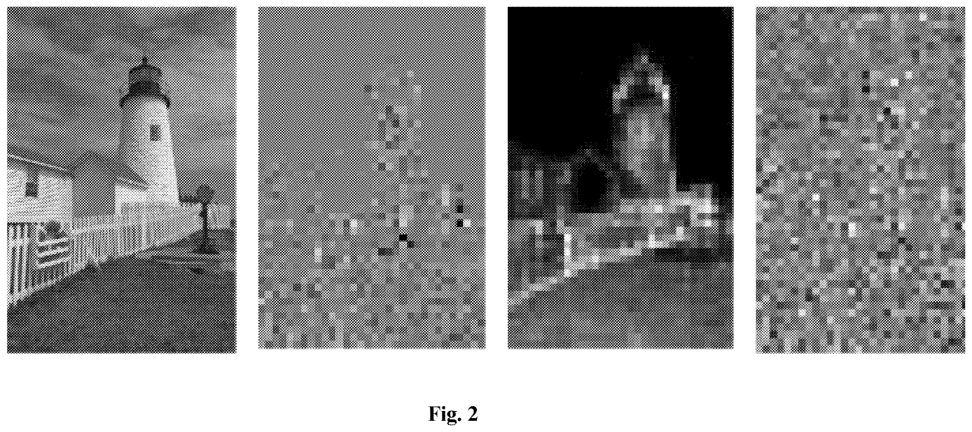

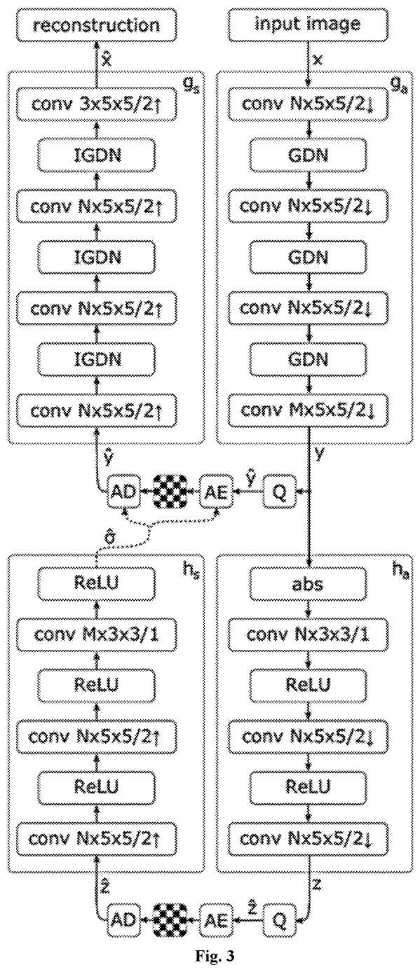

As evident from the middle left and middle right image of FIG. 2, there are significant spatial dependencies among the elements of ŷ. Notably, their scales (middle right image) appear to be coupled spatially. An additional set of random variables \hat{z} are introduced to capture the spatial dependencies and to further reduce the redundancies. In this case the image compression network is depicted in FIG. 3.

In FIG. 3, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent y are reduced. The rightmost image in FIG. 2 correspond to the quantized latent when hyper encoder/decoder are used. Compared to middle right image, the spatial redundancies are significantly reduced, as the samples of the quantized latent are less correlated.

FIG. 2 illustrate an image from the Kodak dataset (left), a visualization of the latent representation y of that image (middle left), standard deviations 6 of the latent (middle right), and latents y after the hyper prior (hyper encoder and decoder) network is introduced (right).

FIG. 3 illustrates a network architecture of a autoencoder implementing the hyperprior model. The left side shows an image autoencoder network, the right side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model consists of two subnetworks, hyper encoder (denoted with hₐ) and hyper decoder (denoted with h). The hyper prior model generates a quantized hyper latent (\hat{z}) which comprises information about the probability distribution of the samples of the quantized latent ŷ. \hat{z} is included in the bitstream and transmitted to the receiver (decoder) along with ŷ.

### 2.3.4 Context Model

Although the hyper prior model improves the modelling of the probability distribution of the quantized latent y, additional improvement can be obtained by utilizing an autoregressive model that predicts quantized latents from their causal context (Context Model).

The term auto-regressive means that the output of a process is later used as input to it. For example the context model subnetwork generates one sample of a latent, which is later used as input to obtain the next sample.

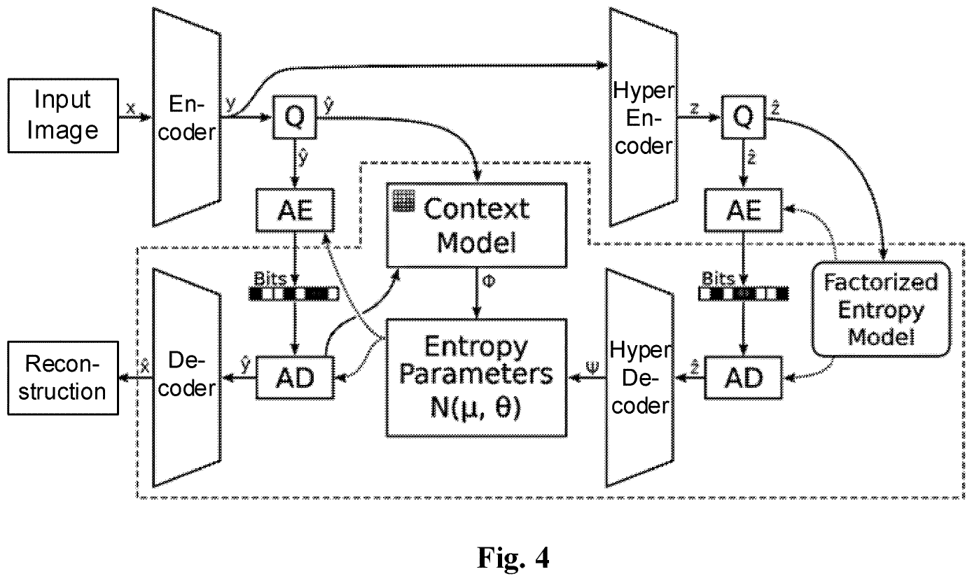

FIG. 4 is a schematic diagram illustrating an example combined model configured to jointly optimize a context model along with a hyperprior and the autoencoder. The following table illustrates meaning of different symbols.

TABLE
Illustration of symbols

| Component | Symbol |
|---|---|
| Input Image | x |
| Encoder | f(x; θₑ) |
| Latents | y |
| Latents (quantized) | ŷ |
| Decoder | g(ŷ; θ_{d}) |
| Hyper Encoder | fₕ(y; θₕₑ) |
| Hyper-Latents | z |
| Hyper-Latents (quantized) | \hat{z} |
| Hyper Decoder | gₕ(\hat{z}; θ_{hd}) |
| Context Model | g_{cm}(y_{<i}; θ_{cm}) |
| Entropy Parameters | gₑₚ(•; θₑₚ) |
| Reconstruction | \hat{x} |

A joint architecture where both hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in FIG. 4, the outputs of context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

FIG. 4 illustrates that the combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

Typically the latent samples are modeled as gaussian distribution or gaussian mixture models (not limited to). According to the FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 Gained Variational Autoencoders (G-VAE)

Typically, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w}, where i=0, 1, . . . , c−1. A pair of gain units include a gain matrix M∈R^{c*n} and an inverse gain matrix, where n is the number of gain vectors. The gain vector can be denoted as mₛ={αₛ₍₀₎, αₛ₍₁₎, . . . , α_{s(c-1)}}, αₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s}$$

Where ⊙ is channel-wise multiplication, i.e., y̅ₛ(i)=y₍ᵢ₎×αₛ(i), and αₛ₍ᵢ₎ is the i-th gain value in the gain vector mₛ. The inverse gain matrix used at the decoder side can be denoted as M′∈R^{c*n}, which consists of n inverse gain vectors, i.e., M′={δₛ₍₀₎, δₛ₍₁₎, . . . , δ_{s(c-1)}}, δₛ₍ᵢ₎∈R. The inverse gain process is expressed as

$${{y}^{′}}_{s} = \hat{y} ⊙ {m}_{s}^{′}$$

where ŷ is the decoded quantized latent representation and y′ₛ is the inversely gained quantized latent representation, which will be fed into the synthesis network.

To achieve continuous variable rate adjustment, interpolation is used between vectors. Given two pairs of gain vectors {mₜ, m′ₜ} and {mᵣ, m′ᵣ}, the interpolated gain vector can be obtained via the following equations.

$${m}_{v} = [ {( {m}_{r} )}^{l} \cdot {( {m}_{t} )}^{1 - l} ]$$

$${m}_{v}^{′} = [ {( {m}_{r}^{′} )}^{l} \cdot {( {m}_{t}^{′} )}^{1 - l} ]$$

where l∈R is an interpolation coefficient, which controls the corresponding bit rate of the generated gain vector pair. Since l is a real number, an arbitrary bit rate between the given two gain vector pairs can be achieved.

### 2.3.6 the Encoding Process Using Joint Auto-Regressive Hyper Prior Model

The FIG. 4. corresponds to the state of the art compression method that is proposed. In this section and the next, the encoding and decoding processes will be described separately.

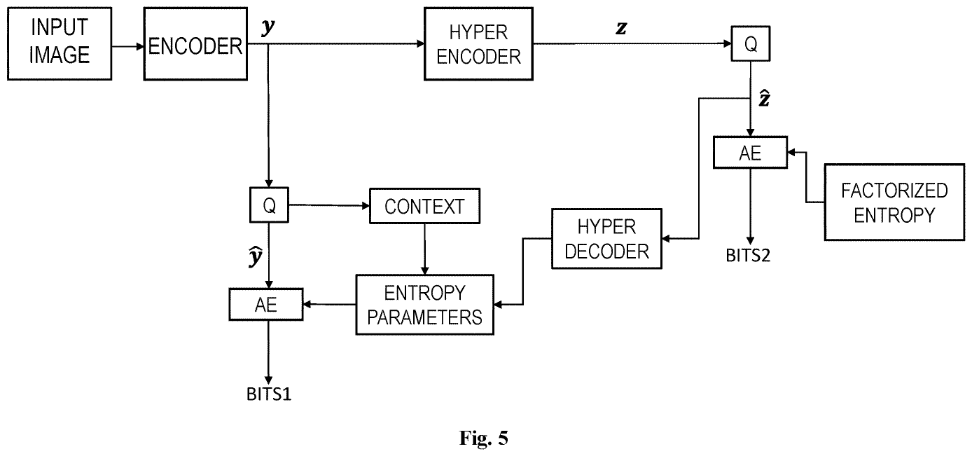

FIG. 5 depicts the encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. The entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent y into bitstream (bits1).

Finally the first and the second bitstream are transmitted to the decoder as result of the encoding process.

It is noted that the other names can be used for the modules described above.

In the above description, the all of the elements in FIG. 5 are collectively called encoder. The analysis transform that converts the input image into latent representation is also called an encoder (or auto-encoder).

### 2.3.7 The Decoding Process Using Joint Auto-Regressive Hyper Prior Model

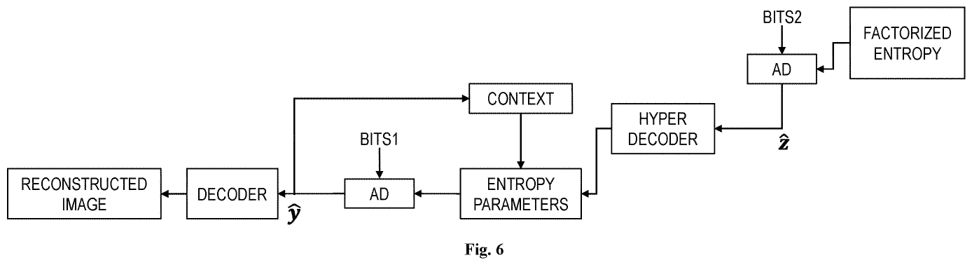

FIG. 6 depicts the decoding process separately corresponding to the encoding process shown in FIG. 5.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore the exact same probability distributions can be obtained in the decoder (as in encoder), which is essential for reconstructing the quantized latent ŷ without any loss. As a result the identical version of the quantized latent y that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally the fully reconstructed quantized latent ŷ is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 2.4 Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.5 Preliminaries

Almost all the natural image/video is in digital format. A grayscale digital image can be represented by x∈ [symbol] ^{m×n}, where [symbol] is the set of values of a pixel, m is the image height and n is the image width. For example, [symbol] ={0, 1, 2, . . . , 255} is a common setting and in this case | [symbol] =256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$M S E = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$P S N R = 10 \times {log}_{10} \frac{{( max ( 𝔻 ) )}^{2}}{M S E} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 2.6 Separate Processing of Luma and Chroma Components of an Image

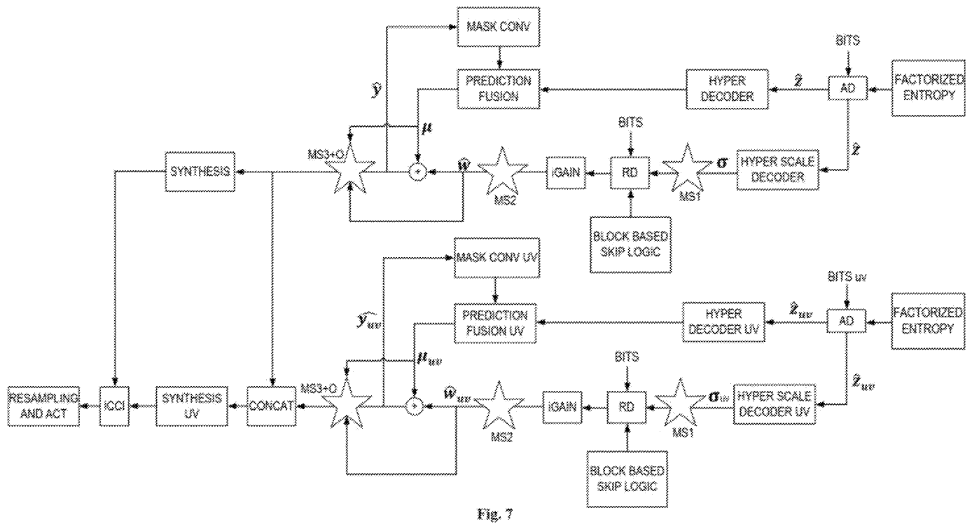

FIG. 7 illustrates a decoding process according to the present disclosure.

According to one implementation, the luma and chroma components of an image can be decoded using separate subnetworks. In FIG. 7, the luma component of the image is processed by the subnetworks “Synthesis”, “Prediction fusion”, “Mask Conv”, “Hyper Decoder”, “Hyper scale decoder” etc. Whereas the chroma components are processed by the subnetworks: “Synthesis UV”, “Prediction fusion UV”, “Mask Conv UV”, “Hyper Decoder UV”, “Hyper scale decoder UV” etc.

A benefit of the above separate processing is that the computational complexity of the processing of an image is reduced by application of separate processing. Typically in neural network based image and video decoding, the computational complexity is proportional to the square of the number of feature maps. If the number of total feature maps is equal to 192 for example, computational complexity will be proportional to 192×192. On the other hand if the feature maps are divided into 128 for luma and 64 for chroma (in the case of separate processing), the computational complexity is proportional to 128×128+64×64, which corresponds to a reduction in complexity by 45%. Typically the separate processing of luma and chroma components of an image does not result in a prohibitive reduction in performance, as the correlation between the luma and chroma components are typically very small.

The processing (Decoding process) in the FIG. 7 can be explained below:
1. Firstly, the factorized entropy model is used to decode the quantized latents for luma and chroma, i.e., \hat{z} and \hat{z}, in FIG. 7.
2. The probability parameters (e.g. variance) generated by the second network are used to generate a quantized residual latent by performing the arithmetic decoding process.
3. The quantized residual latent is inversely gained with the inverse gain unit (iGain) as shown in orange color in FIG. 7. The outputs of the inverse gain units are denoted as ŵ and ŵᵤᵥ for luma and chroma components, respectively.
4. For the luma component, the following steps are performed in a loop until all elements of ŷ are obtained:
   a. A first subnetwork is used to estimate a mean value parameter of a quantized latent (ŷ), using the already obtained samples of ŷ.
   b. The quantized residual latent ŵ and the mean value are used to obtain the next element of ŷ.
5. After all of the samples of ŷ are obtained, a synthesis transform can be applied to obtain the reconstructed image.
6. For chroma component, steps 4 and 5 are the same but with a separate set of networks.
7. The decoded luma component is used as additional information to obtain the chroma component. Specifically, the Inter Channel Correlation Information filter sub-network (ICCI) is used for chroma component restoration. The luma is fed into the ICCI sub-network as additional information to assist the chroma component decoding.
8. Adaptive color transform (ACT) is performed after the luma and chroma components are reconstructed. The module named ICCI is a neural-network based postprocessing module. The solution is not limited to the UCCI subnetwork, any other neural network based postprocessing module might also be used.

An exemplary implementation of the solution is depicted in FIG. 7 (the decoding process). The framework comprises two branches for luma and chroma components respectively. In each of the branch, the first subnetwork comprises the context, prediction and optionally the hyper decoder modules. The second network comprises the hyper scale decoder module. The quantized hyper latent are \hat{z} and \hat{z}ᵤᵥ. The arithmetic decoding process generates the quantized residual latents, which are further fed into the iGain units to obtain the gained quantized residual latents ŵ and ŵᵤᵥ.

After the residual latent is obtained, a recursive prediction operation is performed to obtain the latent ŷ and ŷᵤᵥ. The following steps describe how to obtain the samples of latent ŷ[:, i, j], and the chroma component is processed in the same way but with different networks.
1. An autoregressive context module is used to generate first input of a prediction module using the samples ŷ[:, m, n] where the (m, n) pair are the indices of the samples of the latent that are already obtained.
2. Optionally the second input of the prediction module is obtained by using a hyper decoder and a quantized hyper latent [symbol] .
3. Using the first input and the second input, the prediction module generates the mean value mean[:, i, j].
4. The mean value mean[:, i, j] and the quantized residual latent ŵ[:, i,j] are added together to obtain the latent ŷ[:, i, j].
5. The steps 1-4 are repeated for the next sample.

Whether to and/or how to apply at least one method disclosed in the document may be signaled from the encoder to the decoder, e.g. in the bitstream.

Alternatively, whether to and/or how to apply at least one method disclosed in the document may be determined by the decoder based on coding information, such as dimensions, color format, etc.

Alternative or additionally, the modules named MS1, MS2 or MS3+O (in FIG. 7), might be included in the processing flow. The said modules might perform an operation to their input by multiplying the input with a scalar or adding an adding an additive component to the input to obtain the output. The scalar or the additive component that are used by the said modules might be indicated in a bitstream.

The module named RD or the module named AD in the FIG. 7 might be an entropy decoding module. It might be a range decoder or an arithmetic decoder or the like.

The solution described herein is not limited to the specific combination of the units exemplified in FIG. 7. Some of the modules might be missing and some of the modules might be displaced in processing order. Also additional modules might be included. For example:
1. The ICCI module might be removed. In that case the output of the Synthesis module and the Synthesis UV module might be combined by means of another module, that might be based on neural networks.
2. One or more of the modules named MS1, MS2 or MS3+O might be removed. The core of the solution is not affected by the removing of one or more of the said scaling and adding modules.

In FIG. 7, other operations that are performed during the processing of the luma and chroma components are also indicated using the star symbol. These processes are denoted as MS1, MS2, MS3+O. These processing might be, but not limited to, adaptive quantization, latent sample scaling, and latent sample offsetting operations. For example, in an adaptive quantization process might correspond to scaling of a sample with multiplier before the prediction process, wherein the multiplier is predefined or whose value is indicated in the bitstream. The latent scaling process might correspond to the process where a sample is scaled with a multiplier after the prediction process, wherein the value of the multiplier is either predefined or indicated in the bitstream. The offsetting operation might correspond to adding an additive element to the sample, again wherein the value of the additive element might be indicated in the bitstream or inferred or predetermined.

Another operation might be tiling operation, wherein samples are first tiled (grouped) into overlapping or non-overlapping regions, wherein each region is processed independently. For example the samples corresponding to the luma component might be divided into tiles with a tile height of 20 samples, whereas the chroma components might be divided into tiles with a tile height of 10 samples for processing.

Another operation might be application of wavefront parallel processing. In wavefront parallel processing, a number of samples might be processed in parallel, and the amount of samples that can be processed in parallel might be indicated by a control parameter. The said control parameter might be indicated in the bitstream, be inferred, or can be predetermined. In the case of separate luma and chroma processing, the number of samples that can be processed in parallel might be different, hence different indicators can be signalled in the bitstream to control the operation of luma and chrome processing separately.

### 2.7 Colors Separation and Conditional Coding

In one example the primary and secondary color components of an image are coded separately, using networks with similar architecture, but different number of channels as shown in 8. All boxes with same names are subnetworks with the similar architecture, only input-output tensor size and number of channels are different. Number of channels for primary component is Cₚ=128, for secondary components is Cₛ=64. The vertical arrows (with arrowhead pointing downwards) indicate data flow related to secondary color components coding. Vertical arrows show data exchange between primary and secondary components pipelines.

The input signal to be encoded is notated as x, latent space tensor in bottleneck of variational auto-encoder is y. Subscript “Y” indicates primary component, subscript “UV” is used for concatenated secondary components, there are chroma components.

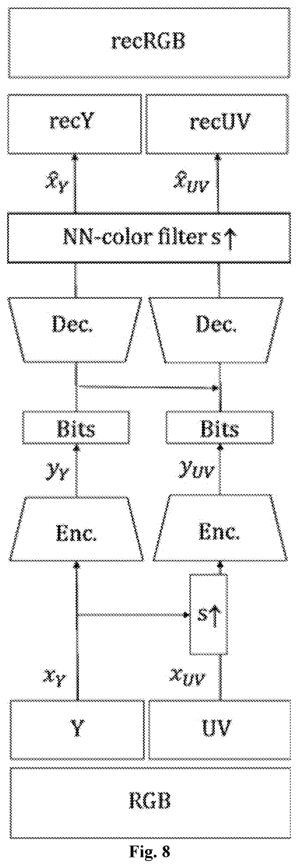

FIG. 8 illustrates learning-based image codec architecture.

First the input image that has RGB color format is converted to primary (Y) and secondary components (UV). The primary component x_{Y} is coded independently from secondary components x_{UV} and the coded picture size is equal to input/decoded picture size. The secondary components are coded conditionally, using x_{Y} as auxiliary information from primary component for encoding x_{UV} and using ŷ_{Y} as a latent tensor with auxiliary information from primary component for decoding ŷ_{UV} reconstruction. The codec structure for primary component and secondary components are almost identical except the number of channels, size of the channels and the several entropy models for transforming latent tensor to bitstream, therefore primary and secondary latent tensor will generate two different bitstream based on two different entropy models. Prior to the encoding x_{Y}, x_{UV} goes through a module which adjusts the sample location by down-sampling (marked as “s↓” on FIG. 8), this essentially means that coded picture size for secondary component is different from the coded picture size for primary component. The scaling factor s is variable, but the default scaling factor is s=2. The size of auxiliary input tensor in conditional coding is adjusted in order the encoder receives primary and secondary components tensor with the same picture size. After reconstruction, the secondary component is rescaled to the original picture size with a neural-network based upsampling filter module (“NN-color filter s↑” on FIG. 8), which outputs secondary components up-sampled with factor s.

The example in FIG. 8 exemplifies an image coding system, where the input image is first transformed into primary (Y) and secondary components (UV). The outputs \hat{x}_{Y}, x_{UV} are the reconstructed outputs corresponding to the primary and secondary components. At the and of the processing, \hat{x}_{Y}, x_{UV} are converted back to RGB color format. Typically the x_{UV} is downsampled (resized) before processing with the encoding and decoding modules (neural networks). For example the size of the x_{UV} might be reduced by a factor of 50% in each of the vertical and horizontal dimensions. Therefore the processing of the secondary component includes approximately 50%×50%=25% less samples, therefore it is computationally less complex.

### 2.8 The JPEG AI Image Coding Standard

At the time of writing, the JPEG AI image coding standard is an image coding standard that is being standardized by the JPEG Working Group (WG), which is WG 1 of ISO/IEC JTC 1 SC 29. The ISO/IEC number for the JPEG AI standard is ISO/IEC 6048. The latest JPEG AI draft specification is included in JPEG output document WG1N100602.

The design in the latest JPEG AI draft specification utilizes some NN-based image coding methods described mentioned above. Some of the features in the latest JPEG AI specification are described or summarized below.

### 2.8.1 Quantized Convolution

Two-dimensional quantized convolution is denoted as qCONV(Kᵥₑᵣ×Kₕₒᵣ, Cᵢₙ, Cₒᵤₜ, s ↓, d, p). Convolution process receives an integer tensor of size [Cᵢₙ, hᵢₙ, wᵢₙ] and outputs an integer tensor of size [Cₒᵤₜ, hₒᵤₜ, wₒᵤₜ], where hᵢₙ=s·hₒᵤₜ; wᵢₙ=s·wₒᵤₜ, factor s is called stride. In absence of the stride argument, it is equal to 1 by default, meaning no spatial resolution change is performed. The parameter d is a non-negative integer number, which defines maximum magnitude of input tensor element after clipping. The tensor p[Cₒᵤₜ] contains de-scaling shifts for each channel of output tensor.

Operations in quantized convolution can be described as three-steps operation:

$$temp [ {c}_{in} , i , j ] = clip ( - d , d - 1 , input [ {c}_{in} , i , j ] ) , i = 0 , ... , {h}_{in} - 1 ; j = 0 , ... , {w}_{in} - 1 ; {c}_{in} = 0 , ... , {C}_{in} - 1 ; R [ {c}_{out} , i , j ] = bias [ {c}_{out} ] + {\sum }_{{c}_{in} = 0}^{{C}_{in} - 1} weigth [ {c}_{in} , {c}_{out} ] ★temp [ {c}_{in} , s \cdot i , s \cdot j ] ;$$

where “★” is 2D cross-correlation operator with kernel size Kᵥₑᵣ×Kₕₒᵣ.

$$out [ {c}_{out} , i , j ] = ( R [ {c}_{out} , i , j ] ) ≫ p [ {c}_{out} ] ; i = 0 , ... , \\ {h}_{out} - 1 ; j = 0 , ... , {w}_{out} - 1 ; {c}_{out} = 0 , ... , {C}_{out} - 1.$$

The tensor weigth of shape [Cᵢₙ, Cₒᵤₜ, Kᵥₑᵣ, Kₕₒᵣ] contains learnable integer weights, the tensor bias of shape [Cₒᵤₜ,] contains learnable integer biases. All parameters weigth and bias are part of the learnable quantized model.

The combination of clipping value d, de-scaling shifts p[cₒᵤₜ] and magnitude for the quantized model parameters allows control over bit depth of register R[cₒᵤₜ, i,j].

### 2.8.2 Deinteger Function

Denotes as deinterger (wP,A). The input of the function is bitdepth wP and integer input value A.
Output of this function is float point value out.
   | The variables add and max are assigned as:

$$add = {2}^{( wP - 5 )} ,$$

$$max = {2}^{wP} - 1 ,$$

⊏ the output out is set equal to (A−max/2)÷add.

### 2.8.3 Bit-Wise Operators

The following bit-wise operators are defined as follows:
Bit-wise “and”. When operating on integer arguments, operates on a two's complement
& representation of the integer value. When operating on a binary argument that contains fewer bits than another argument, the shorter argument is extended by adding more significant bits equal to 0.
   | Bit-wise “or”. When operating on integer arguments, operates on a two's complement representation of the integer value. When operating on a binary argument that contains fewer bits than another argument, the shorter argument is extended by adding more significant bits equal to 0.
Bit-wise “exclusive or”. When operating on integer arguments, operates on a two's complement
\hat{ } representation of the integer value. When operating on a binary argument that contains fewer bits than another argument, the shorter argument is extended by adding more significant bits equal to 0. Arithmetic right shift of a two's complement integer representation of x by y binary digits. This function is defined only for non-negative integer values of y. Bits shifted into the MSBs as a result
x>>y of the right shift have a value equal to the MSB of x prior to the shift operation.
Arithmetic left shift of a two's complement integer representation of x by y binary digits. This
x<<y function is defined only for non-negative integer values of y. Bits shifted into the LSBs as a result of the left shift have a value equal to 0.
−− Decrement, i.e., x−− is equivalent to x=x−1; when used in an array index, evaluates to the value of the variable prior to the decrement operation.
+= Increment by amount given, i.e., x+=3 is equivalent to x=x+3, and x+=(−3) is equivalent to x=x+(−3).
−= Decrement by amount given, i.e., x−=3 is equivalent to x=x−3, and x−=(−3) is equivalent to x=x−(−3).

### 2.8.4 Decoder Side Up-Sampling for Secondary Component

Depending on output picture and ratio between sizes of primary and secondary components in coded picture format up-sampling in vertical (with scaling factor sᵥₑᵣ) or horizontal (with scaling factor sₕₒᵣ) direction for secondary component is performed. Supported combinations of output picture format and corresponding sizes of primary (H_{Y}×W_{Y}) and secondary (H_{UV}×W_{UV}), also component scaling factors are listed in Table 1.

TABLE 1
Supported combinations of output picture format and scaling factors

| Output picture | Color sampling mode for | | |
|---|---|---|---|
| color sampling mode | coded picture | sᵥₑᵣ | sₕₒᵣ |
| 4:4:4 | 4:4:4 | 1 | 1 |
| H_{Y} = H_{UV} = H | 4:2:2 | 1 | 2 |
| W_{Y} = W_{UV} = W | 4:2:0 | 2 | 2 |
| 4:2:2 | 4:4:4 | Not applicable | Not applicable |
| H_{Y} = H_{UV} = H | 4:2:2 | 1 | 1 |
| W_{Y} = W; W_{UV} = W/2 | 4:2:0 | 1 | 2 |
| 4:2:0 | 4:4:4 | Not applicable | Not applicable |
| H_{Y} = H; H_{UV} = H/2 | 4:2:2 | Not applicable | Not applicable |
| W_{Y} = W; W_{UV} = W/2 | 4:2:0 | 1 | 1 |

If scaling factor sₕₒᵣ>1 or Sᵥₑᵣ>1 then up-sampling is performed for secondary component. By default up-sampling is bi-cubic:

$$For c = 0 .. 1 , i = 0 , .. {H}_{UV} - 1 , j = 0 , .. {W}_{UV} - 1 :$$

$${x}_{UV}^{′} [ c , i , j ] = bi - cubic ( {x}_{UV} [ i , j ] , {s}_{ver} , {s}_{hor} ) .$$

If adaptive upsampler is enabled (EFE_enabled_flag is true) then primary component guided adaptive upsampler is performed.

If adaptive upsampler is enabled (EFE_enabled_flag is false) then x′_{UV} after bi-cubic up-sampling goes to the Inter Channel Correlation Information Filter.

### 2.8.5 Bitstream Structure

The structure of a JPEG AI bitstream (also referred to as code stream or codestream) is composed of six parts with byte boundary, which are:
1. SOC—Start Of Codestream marker;
2. PIH (Picture Header marker) followed by picture header;
3. TOH (Tools Header marker) followed by tools information;
4. SOZ (Start of Z-stream marker) followed codestream of hyper tensor z, including \hat{z}_{Y} and \hat{z}_{UV};
5. SORp (Start of primary component residual stream marker) followed by codestream of primary component residual, which includes \hat{r}_{Y};
6. SORs (Staff of primary component secondary stream marker) followed by codestream of secondary component residual, which includes \hat{r}_{UV};
7. EOC—End Of Codestream marker.

The overall syntax structure of an image is:

| | Descriptor |
|---|---|
| picture( ) { | |
| SOC | u(32) |
| picture_header( ) | |
| tools_header( ) | |
| z_stream( ) | |
| r_primary_stream( ) | |
| r_secondary_stream( ) | |
| EOC | u(32) |
| } | |

Each code stream starts with marker. All markers used in this specification are as follows:

| Code assignment | Symbol | Description | Mandatory/Optional |
|---|---|---|---|
| 0xff80 | SOC | Start of codestream | Mandatory |
| 0xff81 | EOC | End of codestream | Mandatory |
| 0xff82 | PIH | Picture header | Mandatory |
| 0xff83 | TOH | Tools header | Optional |
| 0xff84 | VUI | Reserved for rendering information | Optional |
| 0xff85 | xxx | Reserved | Optional |
| 0xff86 | xxx | Reserved | Optional |
| 0xff87 | xxx | Reserved | Optional |
| 0xff88 | SOZ | Start of z | Mandatory |
| 0xff89 | SORp | Start of residual (primary | Mandatory |
| | | component) | |
| 0xff8a | SORs | Start of residual (secondary | Optional |
| | | component) | |
| 0xff8b | SOQ | Start of quality map | Optional |
| 0xff8c | xxx | Reserved | Optional |
| 0xff8d | xxx | Reserved | Optional |
| 0xff8e | xxx | Reserved | Optional |
| 0xff8f | xxx | Reserved | Optional |

### 2.8.6 Picture Header

This sub-stream contains information about image height H, width W, latent space tiles location and sizes, control flags for each tool, scaling factors for primary and secondary component, modelIdx—learnable model index and displacement for rate control parameters (β_{Y} for primary and β_{UV} for secondary component).

The syntax and semantics are as follows:

### Syntax Table

| | Descriptor |
|---|---|
| picture_header( ) { | |
| PIH | u(32) |
| img_width | u(16) |
| img_height | u(16) |
| picture_format | u(2) |
| bit_depth | u(1) |
| res_changer_header( ) | |
| model_header( ) | |
| } | |

### Resolution Changer Syntax

| | Descriptor |
|---|---|
| res_changer_header( ) { | |
| res_changer_enable | u(1) |
| if ( res_changer_enable ){ | |
| for (dim=0; dim < 2; ++ dim){ | |
| scale_comp[dim] | u(1) |
| } | |
| } | |
| } | |

### Model Header

| | Descriptor |
|---|---|
| model_header( ) { | |
| independent_beta_uv | u(1) |
| beta_displacement_log_y | u(12) |
| if( independent_beta_uv ) | |
| beta_displacement_log_uv | u(12) |
| model_id | u(3) |
| opIdx | u(1) |
| skip_mode_header( ) | |
| tile_header_Luma( ) | |
| tile_header_Chroma( ) | |
| coding_mode_header( ) | |
| color_transform_header( ) | |
| } | |
| skip_mode_header( ) { | |
| for (comp=0; comp < 2; ++ comp){ | |
| s_ver=( comp==0 )? 1: scale_comp[0] | |
| s_hor=( comp==0 )? 1: scale_comp[1] | |
| h4= ceil(ceil(img_height/ s_ver)/(2\hat{ }4)) | |
| w4= ceil(ceil(img_width/ s_hor)/(2\hat{ }4)) | |
| cube_flag_header (h4, w4, comp) | |
| } | |
| } | |
| cube_flag_header (height, width, comp) { | |
| NumCubeFlag =( (height + 7) >> 3) * ( ( width + 7 ) >> 3) | |
| NumCubeFlagGroup = ( NumCubeFlag + 7) >> 3 | |
| for( i = 0; i < NumCubeFlagGroup; i++ ) { | |
| group_flag | u(1) |
| NumCubeInGroup = (i < NumCubeFlagGroup − 1) ? 8: | |
| NumCubeFlag − (NumCubeFlagGroup − 1) * 8 | |
| if( group_flag ) { | |
| for( j = 0; j < NumCubeInGroup; j++ ) { | |
| if( comp == 0) | |
| cube_luma_flag[comp ][i * 8 + j ] | u(1) |
| else | |
| cube_chroma_flag[comp ][i * 8 + j ] | u(1) |
| } | |
| } | |
| else{ | |
| for( j = 0; j < NumCubeInGroup; j++ ) { | |
| if( comp == 0) | |
| cube_luma_flag[comp ][i * 8 + j ]=1 | |
| else | |
| cube_chroma_flag[comp ][i * 8 + j ]=1 | |
| } | |
| } | |
| } | |
| } | |
| tile_header_Luma(tile_signaling_type) { | |
| tile_enable_Luma | u(1) |
| if (tile_enable_Luma) | |
| tile_size_Luma | u(13) |
| tile_overlap_Luma | u(8) |
| } | |
| tile_header_Chroma(tile_signaling_type) { | |
| tile_enable_Chroma | u(1) |
| tile_size_Chroma | u(13) |
| tile_overlap_Chroma | u(8) |
| } | |
| color_transform_header( ) { | |
| color_transform_enable | u(1) |
| if( color_transform_enable ) | |
| for ( i=0;i<3;i++ ) | |
| for ( j=0;j<3;j++ ) | |
| color_transform_matrix[i][j] | u(8) |
| for ( i=0;i<3;i++ ) | |
| color_transform_offset[i] | u(8) |
| } | |

Following serves information is signalled:
PIH is 32-bits marker which includes type (first two-bytes) and picture header size (last two-bytes);
img_width plus 64 specifies width of an input picture (from 64 to 65600);
img_height plus 64 specifies height of the input picture (from 64 to 65600);
picture_format is a data format of the output picture (YUV420=0, YUV444=1, sRGB=2, YUV444=3);
bit_depth is a bit-depth the output picture (“0” corresponds to 8 and “1” corresponds to 10);
res_changer_enable is an enable flag for resolution changer tool.
scale_comp[2] are vertical and horizontal ratio between primary and secondary components sizes of coded picture sᵥₑᵣ=scale_comp[0] and sₕₒᵣ=scale_comp[1]; if not present (res_changer_enable=false) then sᵥₑᵣ=2 and sₕₒᵣ=2
independent_beta_uv is a flag (false/true) which indicates do the rate control parameter (β) for primary and secondary components are the same.
beta_displacement_log_y—parameter indicating ratio between rate control parameter beta selected by encoder for primary component and one used in the model training.
betaDisplacementLogY=beta_displacement_log_y−2¹¹
beta_displacement_log_uv—parameter indicating ratio between rate control parameter beta selected by encoder for secondary component and one used in the model training.
betaDisplacementLogUV=beta_displacement_log_uv−2¹¹
model_id is an identificator of pre-stored checkpoint with model's weights, model_id=0, 1, 2, 3 or 4.
opIdx is an identificator for operation point, 0 means “base”, 1 means “high” operation point.
tile_enable_Luma and tile_enable_Chroma are enable flags for tiling of primary and secondary components.
tile_size_Luma and tile_size_Chroma are size of tiles for primary and secondary components.
tile_overlap_Luma and tile_overlap_Luma are sizes of tiles overlapping areas for primary and secondary components.
cube_group_flag is 1-bit unsigned integer. cube_group_flag=0 indicates no cube_flag is signalled in one group, and cube flags of one group are set to be 1. cube_group_flag=1 indicates cube flags of one group are signaled.
cube_luma_flag is 1D array of size ((h_{4,Y}+7)>>3)·((w_{4,Y}+7)>>3), which contains cube flags for primary component. 1 indicates Skip Mode is applied to one cube of residual tensor of primary component \hat{r}_{Y}. 0 indicates Skip Mode is disable for one cube of residual tensor of primary component \hat{r}_{Y}.
cube_chroma_flag is 1D array of size ((h_{4,UV}+7)>>3)·((w_{4,UV}+7)>>3), which contains cube flags for secondary component. 1 indicates Skip Mode is applied to one cube of residual tensor of secondary component \hat{r}_{UV}. 0 indicates Skip Mode is disable for one cube of residual tensor of secondary component \hat{r}_{UV}.
color_transform_enable is an enable flag for color convertion module.
color_transform_matrix[i][j] is a matrix of color convertion. If not present (color_transform_enable is false) then default ITU-R BT.709 colour transform is used.
color_transform_offset[i] is an offset for color transformation If not present (color_transform_enable is false) then default ITU-R BT.709 colour transform is used.

### 2.8.7 Tools Header

This optional sub-stream contains information about tools.

Tools header syntax table

| | |
|---|---|
| tools_header( ) { | Descriptor |
| TOH | u(32) |
| rvs_header() | |
| lsbs_header() | |
| EFE_upsampler_parameters () | |
| ICCI_header() | |
| EFE_non_linear_filter_parameters( ) | |
| LEF_parameters() | |
| Gain_parameters() | |
| } | |
| EFE_upsampler_parameters( ) { | Descriptor |
| EFE_upsampler_enabled_flag | u(1) |
| if (EFE_upsampler_enabled_flag){ | |
| B₁[0] | u(15) |
| B₁[1] | u(15) |
| W_{1A}, W_{1B}, best_cand_idx1 = decodeFilters() | |
| W_{4A}, W_{4B}, best_cand_idx2 = decodeFilters() | |
| } | |
| } | |
| EFE_non_linear_filter_parameters( ) { | Descriptor |
| EFE_nonlinear_filter_enabled_flag | |
| If (EFE_nonlinear_filter_enabled_flag){ | |
| minSymbol | u(16) |
| maxSymbol | u(16) |
| maxSymbol = ceil(log2(maxSymbol)) | |
| mask1_enabled_flag | u(1) |
| mask2_enabled_flag | u(1) |
| if (maskl_enabled_flag OR mask2_enabled_flag){ | |
| bS | u(10) |
| len_mask_y | u(10) |
| len_mask_x | u(10) |
| } | |
| *** Initialize tensor to all zeros *** | |
| for (i = 0, i < mask1_enabled_flag * len_mask_y, i++) | |
| for (j = 0, i < mask1_enabled_flag * len_mask_x, j++) | |
| W₅[i, j, 0] | u(3) |
| for (i = 0, i < mask2_enabled_flag * len_mask_y, i++) | |
| for (j = 0, i < mask2_enabled_flag * len_mask_x, j++) | |
| W₅[i, j, 1] | u(3) |
| nonLinear_enabled_U_flag | uf(1) |
| nonLinear_enabled_V_flag | uf(1) |
| if (nonLinear_enabled_U_flag OR nonLinear_enabled_V_flag){ | |
| nonlinearW | u(16) |
| nonlinearH | u(16) |
| numTiles | u(16) |
| for (i = 0, i < numTiles, i++){ | |
| min Luma[i] | u(16) |
| } | |
| for (i = 0, i < numTiles, i++){ | |
| maxLuma[i] | u(16) |
| } | |
| } | |
| if (nonLinear_enabled_U_flag){ | |
| candNum | u(16) |
| for (i = 0, i < candNum, i++){ | |
| A1 | u(maxSymbol) |
| ${W}_{3} [ \frac{i}{8} , 0 , i \% 8 ] = deinteger ( A 1 + minSymbol , 16 )$ | |
| } | |
| } | |
| if (nonLinear_enabled_V_flag){ | |
| candNum | u(16) |
| for (i = 0, i < candNum, i++){ | |
| A1 | u(maxSymbol) |
| ${W}_{3} [ \frac{i}{8} , 1 , i \% 8 ] = deinteger ( A 1 + min Symbol , 16 )$ | |
| } | |
| } | |
| } | |
| } | |
| decodeFilters( ) { | Descriptor |
| best_cand_idx[0] | u(4) |
| best_cand_idx[1] | u(4) |
| if(best_cand_idx[0] > 0) | |
| fl[0] | u(4) |
| if(best_cand_idx[1] > 0) | |
| fl[1] | u(4) |
| minSymbol | u(16) |
| maxSymbol | u(16) |
| maxSymbol = ceil(log2(maxSymbol)) | |
| *** Initialize WA[6,8,4,4], WB[6,2,4,4] tensors to all zeros *** | |
| for (comp = 0, comp < 2, comp++){ | |
| if (best_cand_idx[comp]>0){ | |
| WA[:, (comp*4) ... (comp*4+3), :, :] = decode_one_filter | |
| ( cand[best_cand_idx[comp]][1], 4, fl[comp], maxSymbol, minSymbol) | |
| WB[:, comp, :, :] = decode_one_filter (cand[best_cand_idx[comp][1], 1, | |
| fl[comp], maxSymbol, minSymbol) | |
| } | |
| return WA, WB, best_cand_idx | |
| } | |
| decode_one_filter( numFilter, numPlane, fl, maxSymbol, minSymbol) { | Descriptor |
| * * *Initialize W[6, numPlane, 4,4] tensor to all zeros | |
| for (i = 0, i < numFilter, i++) | |
| for (j = 0, j < numPlane, j++) | |
| for (fl_hor = 0, fl_hor < fl - 1, fl_hor++) | |
| for (fl_ver = 0, fl_ver < fl - 1, fl_ver++) | |
| A | u(maxSymbol) |
| W[i, j, f1/2 + fl_hor, fl/2 + fl_ver] = deinteger(A+ minSymbol,16) | |
| return W | |
| } | |

The values of fl[0], fl[1], best_cand_idx[0] and best_cand_idx[1] are restricted to be 1 in the first invocation of decodeFilters( ).
TOH is 32-bits marker which includes type (first two-bytes) and tools header size (last two-bytes);
EFE_upsampler_enabled_flag—flag indicating if EFE luma-aided upsampling process is enabled.
EFE_nonlinear_filter_enabled_flag—flag indicating if EFE nonlinear filtering processed is enabled.
best_cand_idx[0]—the 4 bit non-negative integer value specifying the candidate index corresponding to the u-component (first one of the secondary components), indicating the number of tiles and the tile coordinates. It is used as input to cand [X][Y] table.
best_cand_idx[1]—the 4 bit non-negative integer value specifying the candidate index corresponding to the v-component (second one of the secondary components), indicating the number of tiles and the tile coordinates. It is used as input to cand [X][Y].
f[0]—the 9-valued non-negative integer value specifying the kernel size. The value of fl[0] is restricted to be smaller than 4 and greater than 0.
fl[1]—the 9-valued non-negative integer value specifying the kernel size. The value of fl[1] is restricted to be smaller than 4 and greater than 0.
W_{1A}—the 4-dimensional tensor specifying the multiplier coefficients, e.g. weights.
W_{1B}—the 4-dimensional tensor specifying the multiplier coefficients, e.g. weights.
W_{4A}—the 4-dimensional tensor specifying the multiplier coefficients, e.g. weights.
W_{4B}—the 4-dimensional tensor specifying the multiplier coefficients, e.g. weights.
bS—the 10 bit non-negative integer value specifying the block size of the EFE output adjustment subprocess.
minSymbol—the 16-bit non-negative integer value specifying the the minimum value that is used in deinteger( ) function.
maxSymbol—the 16-bit non-negative integer value specifying the maximum coefficient value.
mask1_enabled_flag—the 1-bit non-negative integer value specifying a if the values of len_mask_1_x and len_mask_1_y are zero or greater than zero.
mask2_enabled_flag—the 1-bit non-negative integer value specifying a if the values of len_mask_2_x and len_mask_2_y are zero or greater than zero.
B1—the 16 bit value specifying the bias (additive component).
nonLinear_enabled_U_flag—on/off switch for nonlinear filtering process of U component.
nonLinear_enabled_V_flag—on/off switch for nonlinear filtering process of V component.
nonlinear_width—width of the weight tensor of the nonlinear filtering process.
nonlinear_height—height of the weight tensor of the nonlinear filtering process.

### 3 Enhancement Filter Technologies in Existing Design

In total four different enhancement filter technologies with different functionalities are included:
Adaptive up-sampler,
Inter Channel Correlation Information Filter,
Non-linear Chroma Enhancement filter,
Luma Edge Filter.

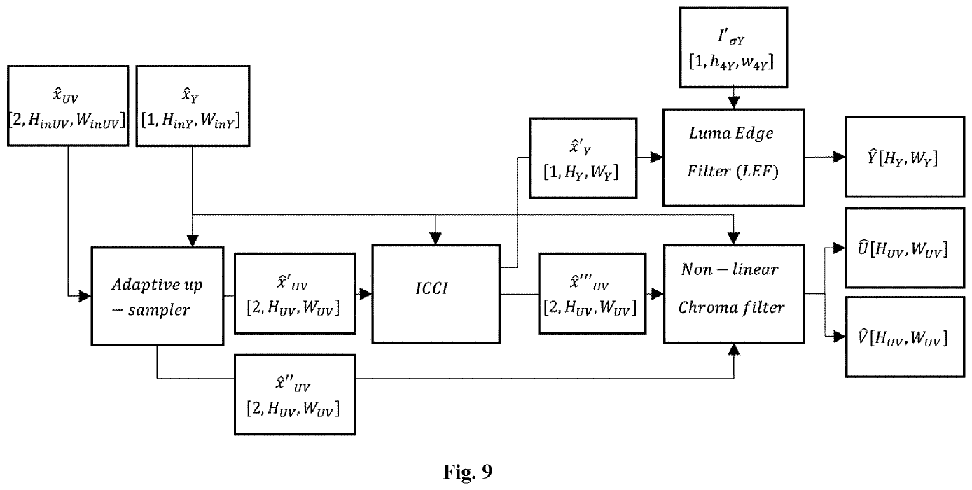

Data flow is show in FIG. 9. The process starts with the output of synthesis transform for primary \hat{x}_{Y}[1, H_{inY}, W_{inY}] and secondary \hat{x}_{UV}[2,H_{inUV}, W_{inUV}] components. The output of filter processing block is reconstructed color components Ŷ, [H_{Y}, W_{y}], Û[H_{UV}, W_{UV}], \hat{V}[H_{UV}, W_{UV}], which go inverse color transform. scaleᵥₑᵣ and scaleₕₒᵣ are set equal to 2H_{inUV}/H and 2W_{inUV}/W, oᵥₑᵣ and oₕₒᵣ are set equal to 2H_{UV}/H and 2W_{UV}/W, and dᵥₑᵣ and dₕₒᵣ are set equal to H/H_{UV} and W/W_{UV} respectively, which are used in the remaining subsections.
NOTE—When coded picture format is 4:2:0 and output picture format is 4:4:4, the values of aleᵥₑᵣ, scaleₕₒᵣ, oᵥₑᵣ, oₕₒᵣ, dᵥₑᵣ and dₕₒᵣ are equal to 1, 1, 2, 2, 1 and 1 respectively.

FIG. 9 illustrates enhancement filter technologies.

Sizes of tensors depending on output and coded picture format are defined in Table 1.

### 3.1 Adaptive Up-Sampler

This section details the primary component guided adaptive up-sampler process. This process provides enhancement of secondary components (colour information planes) of image utilising information from primary component.

This process is enabled if EFE_upsampler_enabled_flag is true.

The input of this process is
\hat{x}_{Y}[1, H_{Y}, W_{Y}](output of synthesis transfor for primary component),
\hat{x}_{UV} [2, H_{inUV}, W_{inUV}](output of synthesis transfor for secondary component),

The output of this process is
enhanced secondary component \hat{x}_{UV} [2, H_{UV}, W_{UV}] which goes to the ICCI filter block and \hat{x}″_{UV} [2, H_{UV}, W_{UV}] which goes to the non-linear filter block.

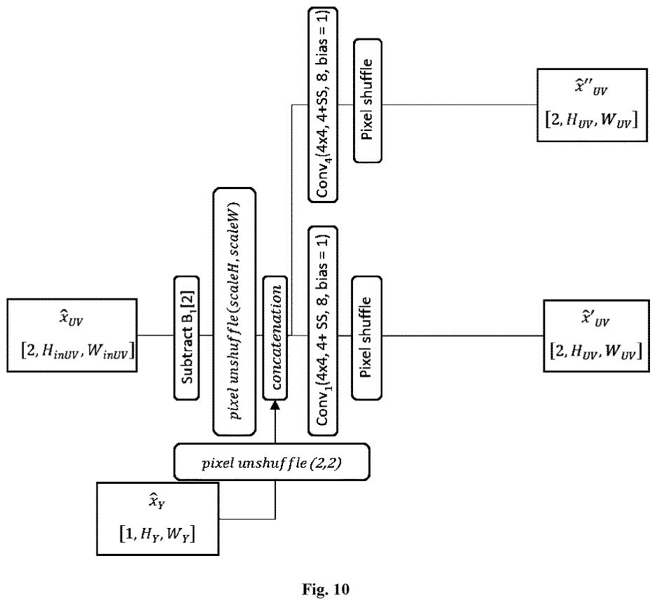

FIG. 10 illustrates an example implementation of primary component guided adaptive up-sampling filter. If EFE_upsampler_enabled_flag is equal to 0, the \hat{x}′_{UV} [2, H, W] is up-sampled by bi-cubic interpolation. Otherwise the following ordered steps are performed:
The parsing process according to a parsing table such as a predefined parsing table in a standard is invoked to obtain W_{1A}, W_{1B}, W_{4A}, W_{4B} and B₁.
Tiling process is as described is invoked with parsed syntax elements as inputs and Tile1 tensor as output.
Parameter update process as specified is invoked with W_{4A} and W_{1A} as inputs and modified W_{4A} and W_{1A} as outputs.
B₁[2] is vector is subtracted channelwise from \hat{x}_{UV}[2, H_{inUV}, W_{inUV}].

$$U [ 2 \cdot {scale}_{ver} \cdot {scale}_{hor} , \frac{H + 1}{2} , \frac{W + 1}{2} ] and Y [ 4 , \frac{H + 1}{2} , \frac{W + 1}{2} ]$$

are set equal to pixelUnshuffle(\hat{x}′_{UV}, scaleᵥₑᵣ, scaleₕₒᵣ) and pixelUnshuffle(\hat{x}′_{Y}, 2,2) respectively.
For x=0 . . . (W+1)/2−1, y=0 . . . (H+1)/2−1, k=0 . . . 1, i=0 . . . oᵥₑᵣ−1, j=0 . . . oₕₒᵣ−1 the following is performed:

$$ch = 4 k + 2 i + j$$

$${ch}_{out} = k \cdot {o}_{ver} \cdot {o}_{hor} + {o}_{hor} \cdot i + j$$

$${ch}_{in} = k \cdot {scale}_{ver} \cdot {scale}_{hor} + {scale}_{hor} \cdot ( i \% {scale}_{ver} ) + ( j \% {scale}_{hor} )$$

$${t}_{idx} = Tile 1 [ k , y , x ]$$

$${U}^{′} [ {ch}_{out} , y , x ] = U [ {ch}_{in} , y , x ] ★ {W}_{4 A} [ {t}_{idx} , ch ] + Y [ 2 i + j , y , x ] ★ {W}_{4 B} [ {t}_{idx} , k ] + {B}_{1} [ k ]$$

$${U}^{′} [ {ch}_{out} , y , x ] = U [ {ch}_{in} , y , x ] ★ {W}_{1 A} [ 0 , ch ] + Y [ 2 i + j , y , x ] ★ {W}_{1 B} [ 0 , k ] + {B}_{1} [ k ]$$

\hat{x}′_{UV}[2,H_{UV},W_{UV}] and \hat{x}″_{UV}[2,H_{UV},W_{UV}] are set equal to pixelshuffle(U′, oᵥₑᵣ, oₕₒᵣ) and pixelshuffle(U″, oᵥₑᵣ, oₕₒᵣ) respectively.

### 3.1.1 Adaptive Up-Sampler Parameters Up-Date Process

Input of this process are weight tensors W_{4A} and W_{1A}.

Output of this process are modified weight tensors W_{4A} and W_{1A}.

The weight tensors W_{4A} and W_{1A} are modified as follows:

For i=0 . . . 3, j=0 . . . 3, ch=0 . . . 3, comp=0 . . . 1, cand=0 . . . 5;

$${W}_{1 A} [ cand , comp \cdot 4 + ch , i , j ] = {W}_{1 A} [ cand , comp \cdot 4 + ch , i , j ] + {W}_{base} [ ch , i , j ]$$

$${W}_{4 A} [ cand , comp \cdot 4 + ch , i , j ] = {W}_{4 A} [ cand , comp \cdot 4 + ch , i , j ] + {W}_{base} [ ch , i , j ]$$

wherein the 3-dimensional W_{base} [4,4,4] tensor is obtained as follows:
┌ W_{base} tensor is initialized by setting all elements to zero.
└ dct_{if} tensor is set as dct_{if}=[−0.0625, 0.5625, 0.5625, −0.0625].
┌ For i=0 . . . 3 and j=0 . . . 3,

$${W}_{base} [ 1 , 1 , i ] = {dct}_{if} [ i ] ,$$

$${W}_{base} [ 2 , i , 1 ] = {dct}_{if} [ i ] ,$$

$${W}_{base} [ 3 , i , j ] = {dct}_{if} [ i ] \cdot {dct}_{if} [ j ] .$$

### 3.1.2 Adaptive Up-Sampler Tiling Process

Inputs to this process the width and the height of the luma reconstructed tensor, and as output of picture header parsing process.

Output of this process is Tile1 tensor.

For comp=0 . . . 1, y=0 . . . (H+1)/2, x=0 . . . (W+1)/2;
X is set equal to best_cand_idx2[comp].
For tileIdx=0 . . . cand[X][1];
Following assignments are made.

$$lowH = round ( cand [ X ] [ 1 + tileIdx ] [ 0 ] \cdot ( H + 1 ) / 2 )$$

$$upperH = round ( cand [ X ] [ 1 + tileIdx ] [ 1 ] \cdot ( H + 1 ) / 2 )$$

$$lowW = round ( cand [ X ] [ 1 + tileIdx ] [ 2 ] \cdot ( W + 1 ) / 2 )$$

$$upperW = round ( cand [ X ] [ 1 + tileIdx ] [ 3 ] \cdot ( W + 1 ) / 2 )$$

Tile1[comp,y,x] is set equal to tileIdx if lowH≤y<upperH and lowW≤x<upperW.

The cand[X][Y][4] table include the number of tiles and the coordinates of the tiles.

| Cand[X][Y] | Y = 1 | Y = 2 | Y = 3 | Y = 4 | Y = 5 | Y = 6 | Y = 7 |
|---|---|---|---|---|---|---|---|
| X = 0 | 0 | | | | | | |
| X = 1 | 1 | [0, 1, 0, 1] | | | | | |
| X = 2 | 2 | [0, 0.5, | [0.5, 1, | | | | |
| | | 0, 1] | 0, 1] | | | | |
| X = 3 | 2 | [0, 1, | [0, 1, | | | | |
| | | 0, 0.5] | 0.5, 1]] | | | | |
| X = 4 | 3 | [0, 1, 0, | [0, 1, 0.33, | [0, 1, | | | |
| | | 0.33] | 0.66] | 0.66, 1] | | | |
| X = 5 | 3 | [0, 0.33, | [0.33, 0.66, | [0.66, 1, | | | |
| | | 0, 1] | 0, 1] | 0, 1] | | | |
| X = 6 | 4 | [0, 0.5, | [0, 0.5, | [0.5, 1, | [0.5, 1, | | |
| | | 0, 0.5] | 0.5, 1] | 0, 0.5] | 0.5, 1] | | |
| X = 7 | 6 | [0, 0.33, | [0, 0.33, | [0.33, 0.66, | [0.33, 0.66, | [0.66, 1, | [0.66, 1, |
| | | 0, 0.5] | 0.5, 1] | 0, 0.5] | 0.5, 1] | 0, 0.5] | 0.5, 1] |
| X = 8 | 6 | [0, 0.5, | [0.5, 1, | [0, 0.5, | [0.5, 1, | [0, 0.5, | [0.5, 1, |
| | | 0, 0.33] | 0, 0.33] | 0.33, 0.66] | 0.33, 0.66] | 0.66, 1] | 0.66, 1] |

### 3.2 Non-Linear Chroma Enhancement Filter

This section details the non-linear filter for of secondary components enhancement.

This process is invoked if EFE_nonlinear_filter_enabled_flag is equal to 1.
The input of this process are \hat{x}′″_{UV} [2, H_{UV}, W_{UV}] as output of ICCI process and \hat{x}″_{UV} [2, H_{UV} W_{UV}] which is the second output of adaptive up-sampler process and x_{Y} [1, H_{y}, W_{y}](the output synthesis transform).
Output of this process are Û[H_{UV}, W_{UV}] and \hat{V}[H_{UV}, W_{UV}].

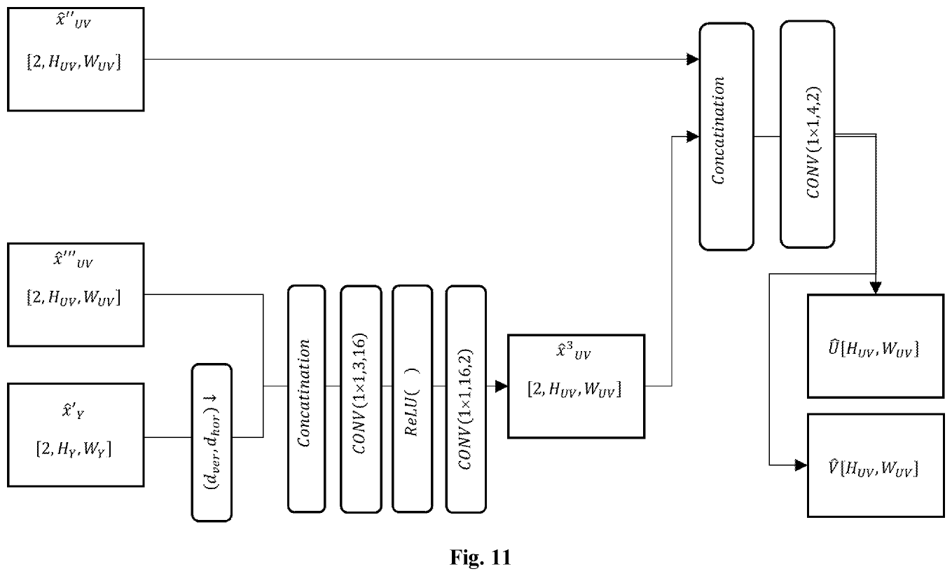

FIG. 11 illustrates an example implementation of EFE non-linear filter.

The following ordered steps are performed:
Non-linear filter parameters tiling process is invoked as described in section 3.2.1 with parsed syntax elements as inputs and Tile2 tensor as output.

The additive bias parameter B₂ [8] is obtained as follows:

[symbol]

$${B}_{2} [ n , i ] = \frac{( n - 8 )}{8} \cdot min Luma [ i ] / 100 - \frac{n}{8} \cdot max Luma [ i ] / 100 , n = 0 … 7$$

NLEnable[0] is set equal to nonLinear_enabled_U_flag, NLEnable[1] is set equal to nonLinear_enabled_V_flag.

[symbol]

$${\hat{x}}_{Y}^{d}$$

is obtained using nearest neighbor downsampling process with \hat{x}′_{Y} as input and (dᵥₑᵣ, dₕₒᵣ) ↓ as [symbol]
downsampling ratios.
   For x=0 . . . W_{UV}−1, y in 0 . . . H_{UV}−1, and k in 0 . . . 1 the following is performed:

$$\text{?} ( k , y , x ) = {\hat{x}}_{UV}^{′′′} ( k , y , x ) + NLEnable [ k ] \cdot {\sum }_{n = 0}^{7} {W}_{3} [ Tile 2 [ y , x ] , k , n ] * RELU ( {\hat{x}}_{Y}^{d} ( 0 , x , y ) + {B}_{2} [ n ] )$$

For x in 0 . . . W_{UV-1}, y in 0 . . . H_{UV}−1 the following is performed:

$$\hat{U} ( y , x ) = {\hat{x}}_{UV}^{″} ( 0 , y , x ) \cdot \frac{{W}_{5} [ \frac{y}{bS} , \frac{x}{bS} , 0 ]}{2} + {\hat{x}}_{UV}^{3} ( 0 , y , x ) \cdot ( 1 - \frac{{W}_{5} [ \frac{y}{bS} , \frac{x}{bS} , 0 ]}{2} )$$

$$\hat{V} ( y , x ) = {\hat{x}}_{UV}^{″} ( 1 , y , x ) \cdot \frac{{W}_{5} [ \frac{y}{bS} , \frac{x}{bS} , 1 ]}{2} + {\hat{x}}_{UV}^{3} ( 1 , y , x ) \cdot ( 1 - \frac{{W}_{5} [ \frac{y}{bS} , \frac{x}{bS} , 1 ]}{2} )$$

### 3.2.1 Non-Linear Filter Parameters Tiling Process

Inputs to this process are nonlinearH, nonlinearW, H_{UV} and W_{UV}.

Output of this process is Tile2 tensor.

Tile2 tensor is obtained as follows:

$$NumVerSplit = ( {H}_{UV} + nonlinearH - 1 ) / nonlinearH ,$$

$$Tile 2 ( y , x ) = ( \frac{y}{nonlinearH} ) * NumVerSplit + ( \frac{x}{nonlinearW} ) , \\ 0 \leq y < {H}_{UV} , 0 \leq x < {W}_{UV} .$$

### 4 Problems

The existing design of JPEG AI includes Enhancement filter technology as described in Section 3, which improves the quality of reconstruction image. However, it remains room to further improve the performance for practical application, which is listed below:
1) The whole enhancement filter is not integerized, which may lead to device interoperability issues.
2) In the Adaptive up-sampler, the number of the Cand can be further increased to improve the performance.
3) Also, in adaptive up-sampler, different filter sizes can be selected to improve the coding performance.
4) Besides, in non-linear filter, the structure still has room to reduce complexity.
5) Moreover, the tile size that is used in adaptive up-sampler and non-linear filter is not multiple of 64.
6) To improve the performance of the up-sampling process of data format (e.g. YUV420 to YUV 444, YUV420 to YUV422, YUV422 to YUV444, etc.), adaptive up-sampler with fixed upsampling weights will be employed.

### 5 Detailed Solutions

To solve the above problems and some other problems not mentioned, methods, as summarized below, are disclosed. The detailed embodiments below should be considered as examples to explain general concepts. These embodiments should not be interpreted narrowly. Furthermore, these embodiments can be combined in any manner.
1) To solve the first problem, the quantization strategy is applied in adaptive up-sampler and non-linear filter. All operations in the adaptive up-sampling filter are integer, an accumulator in all computations is within 32 bits integer diapason, inputs are I_bit bits, weights of the convolution operations are quantized to qw_bit bits integer, and the outputs are O_bit bits. This guarantees the bit-exact behavior of neural network processing. In the adaptive up-sampler, quantized convolution is applied.
   a. In one example, the weights of the convolution that are transmitted in the bitstream are the integer number with bias, to recover the weights after the decoding, the bias shift function is applied in these cases.
      i. In one example, the bias shift function is denoted as biasshift (A, wP). The input of the function is bit depth wP and integer input value A. The output of this function is an integer value out.
      The variable max is assigned as:

$$max = {2}^{wP} - 1 ,$$

the output out is set equal to (A−max/2).
   2. In one example, wP can be any integer number between 1 and 32.
b. In one example, B₁[2] is quantized to support the whole integerized process of adaptive up-sampler.
   i. In one example, let B_bit denote the bits that are used to store the elements of B₁[2]. Before the subtraction that is used in FIG. 10. First, use bitwise operation to scale the B₁[2], which is formulated as:

$${B}_{1} [ 2 ] ≪ ( I\_bit - B\_bit )$$

1. In one example, I_bit might be 16, and B_bit might be 15.
c. In one example, instead of using convolution in FIG. 10, quantized convolution (as mentioned in section 2.8.1) is used, let I_bit denote the bits of the input.
   i. In one example, the clipping value d might be 2<<(I_bit−1).
   ii. In one example, let qw_bit denote the bits of the quantized model parameters, and w_bit denote the bits of unquantized model parameters, the descaling shifts p might be determined by p=qw_bit−w_bit.
      1. In one example, w_bit might be 2, and qw_bit might be 11, and p is 9.
      2. In one example, w_bit might be an integer value between 1 and 32.
      3. In one example, qw_bit might be an integer value between 1 and 32.
   iii. In one example, let B_bit denote the bits that are used to store the elements of B₁[2], the bias of the convolution might be scaled by B₁[2]<<(I_bit−B_bit+qw_bit−w_bit).
      1. In one example, I_bit is 16, B_bit is 15, qw_bit is 11 and w_bit is 2, so B₁[2] will be scaled to B₁[2]<<10.
d. In one example, the adaptive up-sampler parameters up-data process needs to be integerized, the modified process is provided below:
   The weight tensors W_{4A} and W_{1A} are modified as follows:
   For i=0 . . . 3,j=0 . . . 3, ch=0 . . . 3, comp=0 . . . 1, cand=0 . . . 5;

$${W}_{1 A} [ cand , comp \cdot 4 + ch , i , j ] = {W}_{1 A} [ cand , comp \cdot 4 + ch , i , j ] + {W}_{base} [ ch , i , j ]$$

$${W}_{4 A} [ cand , comp \cdot 4 + ch , i , j ] = {W}_{4 A} [ cand , comp \cdot 4 + ch , i , j ] + {W}_{base} [ ch , i , j ]$$

wherein the 3-dimensional W_{base} [4,4,4] tensor is obtained as follows:
   ┌ W_{base} tensor is initialized by setting all elements to zero.
   ┌ dct_{if} tensor is set as dct_{if}=[−32., −224., 288., −32.].
   └ For i=0 . . . 3;
   W_{base}[i, 1,1]=512.
   ⊏ if oᵥₑᵣ is not equal to scaleᵥₑᵣ and oₕₒᵣ is equal to scaleₕₒᵣ, for i=0 . . . 3;

$${W}_{base} [ 2 , i , 1 ] = {dct}_{if} [ i ] ,$$

$${W}_{base} [ 3 , i , 1 ] = {dct}_{if} [ i ] .$$

┌ if oₕₒᵣ is not equal to scaleₕₒᵣ and oᵥₑᵣ is equal to scaleᵥₑᵣ, for i=0 . . . 3;

$${W}_{base} [ 1 , 1 , i ] = {dct}_{if} [ i ] ,$$

$${W}_{base} [ 3 , 1 , i ] = {dct}_{if} [ i ] .$$

└ if oₕₒᵣ is not equal to scaleₕₒᵣ and oᵥₑᵣ is not equal to scaleᵥₑᵣ for i=0 . . . 3 and j=0 . . . 3,

$${W}_{base} [ 1 , 1 , i ] = {dct}_{if} [ i ] ,$$

$${W}_{base} [ 2 , i , 1 ] = {dct}_{if} [ i ] ,$$

$${W}_{base} [ 3 , i , j ] = {dct}_{if} [ i ] \cdot {dct}_{if} [ j ] .$$

2) To solve the second problem, Cand table (in section 3.1.2) can add more potential tile candidates to further improve the performance.
   a. In one example, cand[X][1] can be 8.
      i. In one example, cand[X][2 . . . 9][4] can be [[0, 0.25, 0, 0.5], [0.25, 0.5, 0, 0.5], [0.5, 0.75, 0, 0.5], [0.75, 1, 0, 0.5], [0, 0.25, 0.5, 1], [0.25, 0.5, 0.5, 1], [0.5, 0.75, 0.5, 1], [0.75, 1, 0.5, 0.25]].
      ii. In one example, cand[X][2 . . . 9][4] can be [[0, 0.5, 0, 0.25], [0, 0.5, 0.25, 0.5], [0, 0.5, 0.5, 0.75], [0, 0.5, 0.75, 1], [0.5, 1, 0, 0.25], [0.5, 1, 0.25, 0.5], [0.5, 1, 0.5, 0.75], [0.5, 1, 0.75, 1]].
   b. In one example, cand[X][1] can be 9.
      i. In one example, cand[X][2 . . . 10][4] can be [0.00, 0.33, 0.00, 0.33], [0.00, 0.33, 0.33, 0.67], [0.00, 0.33, 0.67, 1.00], [0.33, 0.67, 0.00, 0.33], [0.33, 0.67, 0.33, 0.67], [0.33, 0.67, 0.67, 1.00], [0.67, 1.00, 0.00, 0.33], [0.67, 1.00, 0.33, 0.67], [0.67, 1.00, 0.67, 1.00].
   c. In one example, cand[X][1] can be 10.
      i. In one example, cand[X][2 . . . 11][4] can be [0.00, 0.50, 0.00, 0.20], [0.00, 0.50, 0.20, 0.40], [0.00, 0.50, 0.40, 0.60], [0.00, 0.50, 0.60, 0.80], [0.00, 0.50, 0.80, 1.00], [0.50, 1.00, 0.00, 0.20], [0.50, 1.00, 0.20, 0.40], [0.50, 1.00, 0.40, 0.60], [0.50, 1.00, 0.60, 0.80], [0.50, 1.00, 0.80, 1.00].
      ii. In one example, cand[X][2 . . . 11][4] can be [0.00, 0.20, 0.00, 0.50], [0.00, 0.20, 0.50, 1.00], [0.20, 0.40, 0.00, 0.50], [0.20, 0.40, 0.50, 1.00], [0.40, 0.60, 0.00, 0.50], [0.40, 0.60, 0.50, 1.00], [0.60, 0.80, 0.00, 0.50], [0.60, 0.80, 0.50, 1.00], [0.80, 1.00, 0.00, 0.50], [0.80, 1.00, 0.50, 1.00].
   d. In one example, cand[X][1] can be 16.
      i. In one example, cand[X][2 . . . 17][4] can be [0.00, 0.50, 0.00, 0.12], [0.00, 0.50, 0.12, 0.25], [0.00, 0.50, 0.25, 0.38], [0.00, 0.50, 0.38, 0.50], [0.00, 0.50, 0.50, 0.62], [0.00, 0.50, 0.62, 0.75], [0.00, 0.50, 0.75, 0.88], [0.00, 0.50, 0.88, 1.00], [0.50, 1.00, 0.00, 0.12], [0.50, 1.00, 0.12, 0.25], [0.50, 1.00, 0.25, 0.38], [0.50, 1.00, 0.38, 0.50], [0.50, 1.00, 0.50, 0.62], [0.50, 1.00, 0.62, 0.75], [0.50, 1.00, 0.75, 0.88], [0.50, 1.00, 0.88, 1.00].
      ii. In one example, cand[X][2 . . . 17][4] can be [0.00, 0.12, 0.00, 0.50], [0.00, 0.12, 0.50, 1.00], [0.12, 0.25, 0.00, 0.50], [0.12, 0.25, 0.50, 1.00], [0.25, 0.38, 0.00, 0.50], [0.25, 0.38, 0.50, 1.00], [0.38, 0.50, 0.00, 0.50], [0.38, 0.50, 0.50, 1.00], [0.50, 0.62, 0.00, 0.50], [0.50, 0.62, 0.50, 1.00], [0.62, 0.75, 0.00, 0.50], [0.62, 0.75, 0.50, 1.00], [0.75, 0.88, 0.00, 0.50], [0.75, 0.88, 0.50, 1.00], [0.88, 1.00, 0.00, 0.50], [0.88, 1.00, 0.50, 1.00].
      iii. In one example, cand[X][2 . . . 17][4] can be [0.00, 0.25, 0.00, 0.25], [0.00, 0.25, 0.25, 0.50], [0.00, 0.25, 0.50, 0.75], [0.00, 0.25, 0.75, 1.00], [0.25, 0.50, 0.00, 0.25], [0.25, 0.50, 0.25, 0.50], [0.25, 0.50, 0.50, 0.75], [0.25, 0.50, 0.75, 1.00], [0.50, 0.75, 0.00, 0.25], [0.50, 0.75, 0.25, 0.50], [0.50, 0.75, 0.50, 0.75], [0.50, 0.75, 0.75, 1.00], [0.75, 1.00, 0.00, 0.25], [0.75, 1.00, 0.25, 0.50], [0.75, 1.00, 0.50, 0.75], [0.75, 1.00, 0.75, 1.00].
3) To solve the third problem, syntax fl will be replaced with fId to support decoding different shapes. The modified syntax parsing table is shown below.

| | Descriptor |
|---|---|
| decodeFilters( ) { | |
| best_cand_idx[0] | u(4) |
| best_cand_idx[1] | u(4) |
| if(best_cand_idx[0] > 0) | |
| fId[0] | u(4) |
| if(best_cand_idx[1] > 0) | |
| fId[1] | u(4) |
| minSymbol | u(16) |
| maxSymbol | u(16) |
| maxSymbol = ceil(log2(maxSymbol)) | |
| ***Initialize WA[6,8,4,4], WB[6,2,4,4] tensors to all zeros*** | |
| for (comp = 0, comp < 2, comp++){ | |
| if (best_cand_idx[comp]>0){ | |
| WA[:, (comp*4)...(comp*4+3), :, :] = decode_one_filter | |
| ( cand[best_cand_idx[comp]][1], 4, fld[comp], maxSymbol, minSymbol) | |
| WB[:, comp, :, :] = decode_one_filter (cand[best_cand_idx[comp][1], 1, | |
| fld[comp], maxSymbol, minSymbol) | |
| } | |
| return WA, WB, best_cand_idx | |
| } | |

| | Descriptor |
|---|---|
| decode_one_filter( numFilter, numPlane, fId, maxSymbol, minSymbol) { | |
| ***Initialize W[6, numPlane ,4,4] tensor to all zeros*** | |
| fl_h = fId_fl_table[fId][0] | |
| fl_w = fId_fl_table[fId][1] | |
| for (i = 0, i < numFilter, i++) | |
| for (j = 0, j < numPlane, j++) | |
| for (fl_hor = 0, fl_hor < fl − 1, fl_hor++) | |
| for (fl_ver = 0, fl_ver < fl − 1, fl_ver++) | |
| A | u(maxSymbol) |
| W[i, j, fl/2 + fl_hor, fl/2 + fl_ver] = deinteger(A+ minSymbol,16) | |
| return W | |
| } | |

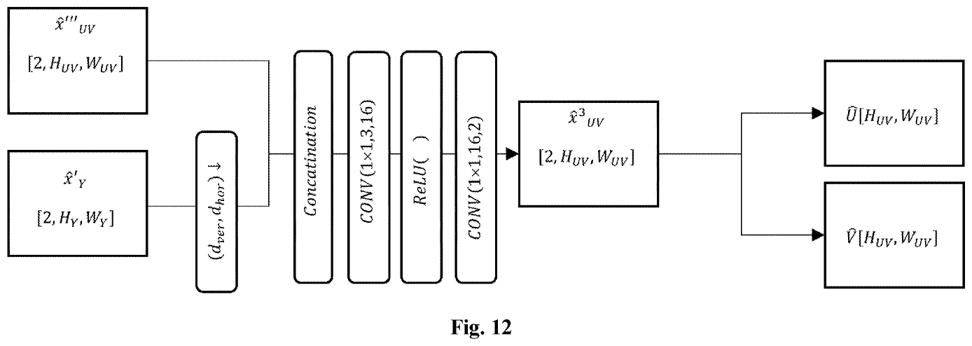

a. In one example, the fId_fl_table is a predefined table.
   i. In one example, the fId_fl_table is a subset of the [(1,1), (2,2), (3,3), (4,4), (2,1), (1,2), (3,1), (1,3), (2,3), (3,2), (1,4), (4,1), (2,4), (4,2), (3,4), (4,3)].
      1. In one example, fId_fl_table is [(1,1), (2,2), (3,3), (4,4)].
      2. In one example, fId_fl_table is [(1,1), (2,2), (2,1), (1,2)].
      3. In one example, fId_fl_table is [(1,1), (2,2), (4,1), (1,4)].
      4. In one example, fId_fl_table is [(1,1), (2,2), (2,1), (1,2), (4,1), (1,4)].
      5. In one example, fId_fl_table is [(1,1), (2,2), (3,3), (4,4), (2,1), (1,2), (3,1), (1,3), (2,3), (3,2), (1,4), (4,1), (2,4), (4,2), (3,4), (4,3)].
b. In one example, the element of the fId is the 9-valued non-negative integer value specifying the kernel size. The value is restricted to be smaller than 4 and greater than 0.
   i. In one example, to support more possible filter sizes, the value may be restricted to be smaller than 16 and greater than 0.
   ii. In one example, to support more possible filter sizes, the value may be restricted to be smaller than 6 and greater than 0.
   iii. In one example, to support more possible filter sizes, the value may be restricted to be smaller than 8 and greater than 0.
   iv. In one example, the maximum value of the fid could be the value between 1 and 16.
c. In one example, to save the bit cost of the fId, the element of the fid is the N-valued non-negative integer value, The value is restricted to be smaller than N and greater than 0.
4) To solve the fourth problem, different modules will be removed to reduce the complexity of the adaptive up-sampler and non-linear chroma enhancement filter.
   a. In one example, the ReLU( ) operation contained in non-linear chroma enhancement will be removed to make it more friendly for network quantization.
   b. In one example, the \hat{x}³_{UV} (k, y, x) will be directly used as the output of the non-linear chroma enhancement.
      i. In one example, \hat{x}′″_{UV} [2, H_{UV}, W_{UV}] will not be calculated in the up-sampler, the related operation will be disabled.
      ii. In one example, the first branch of the non-linear chroma enhancement will be removed, and the framework of the non-linear chroma enhancement can be the structure in FIG. 12, which illustrates an exemplar implementation of the simplified EFE non-linear filter.
5) To solve the fifth problem, the tiling process used in adaptive up-sampler and non-linear chroma enhancement filters needs to be modified to make sure the size of the tile is a multiple of 64.
   a. In one example, in the adaptive up-sampler tiling process (section 3.1.2), for tileIdx=0 . . . cand[X][1]; Following assignments are made:

$$lowH = round ( cand [ X ] [ 1 + tileIdx ] [ 0 ] \cdot \frac{H + 63}{64} ) \cdot 32 ,$$

$$upperH = min ( round ( cand [ X ] [ 1 + tileIdx ] [ 1 ] \cdot ( H + 63 ) / 64 ) \cdot 32 , \frac{H + 1}{2} ) ,$$

$$lowW = round ( cand [ X ] [ 1 + tileIdx [ 2 ] \cdot ( W + 63 ) / 64 ) \cdot 32 ,$$

$$upperW = min ( round ( cand [ X ] [ 1 + tileIdx [ 3 ] \cdot ( W + 63 ) / 64 ) \cdot 32 , \frac{W + 1}{2} ) .$$

b. In one example, in non-linear chroma enhancement filter (section 3.2.1), nonlinearH and nonlinearW shall be multiple of 64.
6) To solve the sixth problem, adaptive up-sampler with fixed weights is applied as the replacement of the up sampling algorithm.
   a. In one example, refer to Table 1, if scaling factor sₕₒᵣ>1 or sᵥₑᵣ>1, EFE_upsampler_enabled_flag is False, instead of using upsampling to scale the shape of the input, adaptive up-sampler with fixed weights is applied.
      i. In one example, adaptive up-sampler with fixed weights might use predefined weights to realize the up-sampling process in adaptive up-sampler, and no adaptative weights is needed to be transmitted bitstream.
         1. In one example, Samples of W_{1A}[1,2,4,4], W_{1B}[1,2,4,4] are set equal to W_{base}.
         2. In one example, the 3-dimensional W_{base} [4,4,4] tensor is obtained as follows:
         W_{base} tensor is initialized by setting all elements to zero.
         dct_{if} tensor is set as dct_{if}=[−32., −224., 288., −32.].
         For i=0 . . . 3;

$${W}_{base} [ i , 1 , 1 ] = 512.$$

if oᵥₑᵣ is not equal to scaleᵥₑᵣ and oₕₒᵣ is equal to scaleₕₒᵣ, for i=0 . . . 3;

$${W}_{base} [ 2 , i , 1 ] = {dct}_{if} [ i ] ,$$

$${W}_{base} [ 3 , i , 1 ] = {dct}_{if} [ i ] .$$

if oₕₒᵣ is not equal to scaleₕₒᵣ and oᵥₑᵣ is equal to scaleᵥₑᵣ, for i=0 . . . 3;

$${W}_{base} [ 1 , 1 , i ] = {dct}_{if} [ i ] ,$$

$${W}_{base} [ 3 , 1 , i ] = {dct}_{if} [ i ] .$$

if oₕₒᵣ is not equal to scaleₕₒᵣ and oᵥₑᵣ is not equal to scaleᵥₑᵣ for i=0 . . . 3 and j=0 . . . 3,

$${W}_{base} [ 1 , 1 , i ] = {dct}_{if} [ i ] ,$$

$${W}_{base} [ 2 , i , 1 ] = {dct}_{if} [ i ] ,$$

$${W}_{base} [ 3 , i , j ] = {dct}_{if} [ i ] \cdot {dct}_{if} [ j ] .$$

b. In one example, a quantized adaptive convolution process is also needed in this process. The detailed quantization solution can be referred to bullet 1).
7) All the above mentioned examples can be combined in any manner, to have a better trade-off between performance and complexity.

### 6 Embodiments

Below are some example embodiments for the detailed solutions aspects summarized above in Section 5.

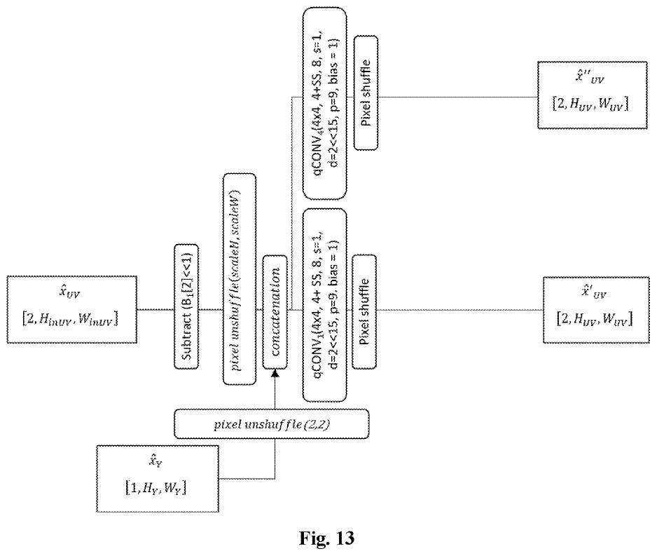

FIG. 13 illustrates an example implementation of quantized primary component guided adaptive up-sampling filter. FIG. 13 shows a quantized primary component guided adaptive up-sampling filter.

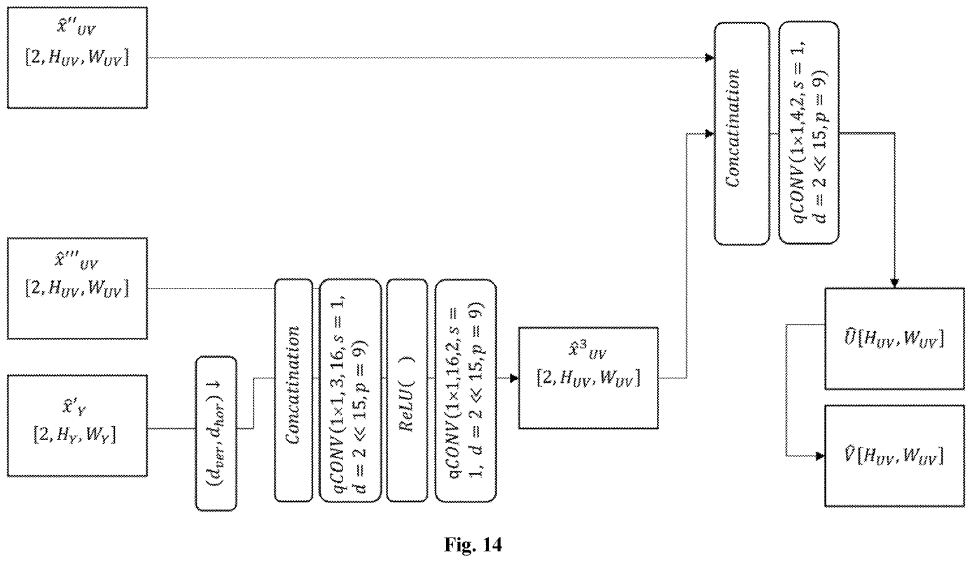

FIG. 14 illustrates an example implementation of quantized EFE non-linear filter. FIG. 14 shows a quantized EFE non-linear filter.

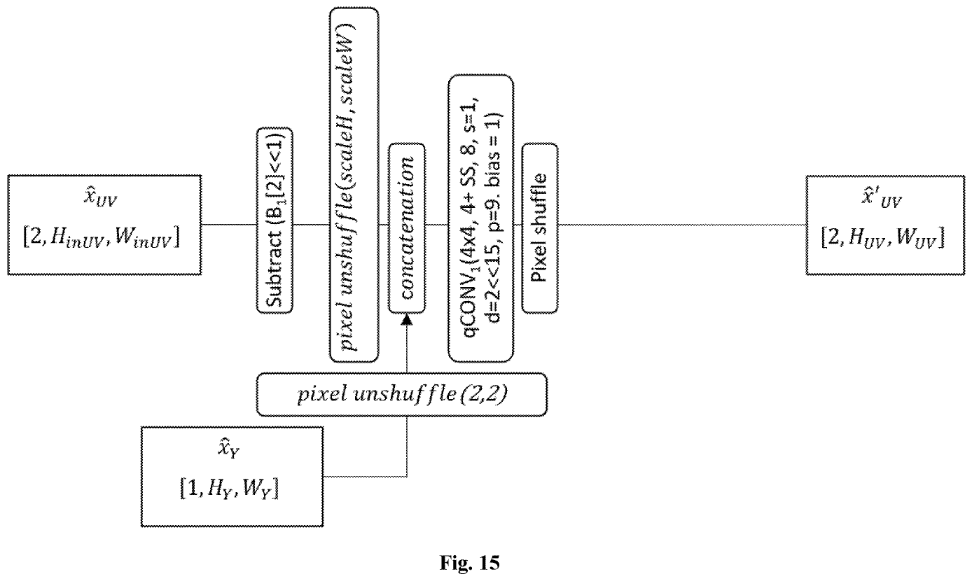

FIG. 15 illustrates an example implementation of simplified primary component guided adaptive up-sampling filter. FIG. 15 shows a simplified primary component guided adaptive up-sampling filter.

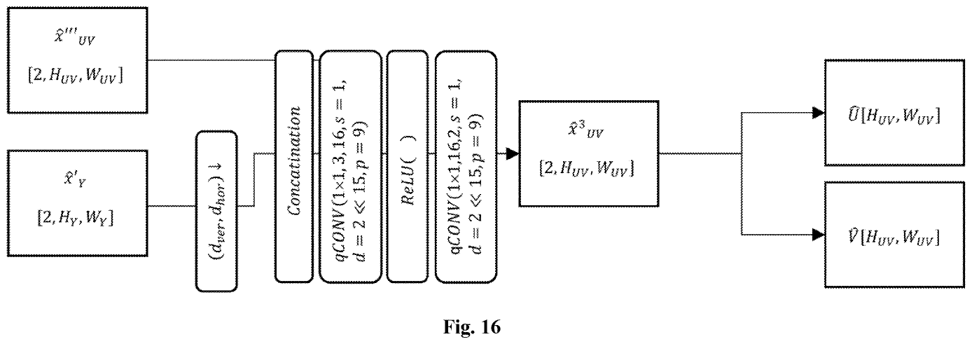

FIG. 16 illustrates an example implementation of simplified EFE non-linear filter. FIG. 16 shows a simplified EFE non-linear filter.

More details of the embodiments of the present disclosure will be described below which are related to neural network-based visual data coding. As used herein, the term “visual data” may refer to an image, a picture in a video, or any other visual data suitable to be coded.

As discussed above, in the existing design for neural network (NN)-based visual data coding, the tile size used in the adaptive up-sampler and the non-linear filter is not required to be a multiple of a predetermined value. This renders the tiling process for the adaptive up-sampler and the non-linear filter not well-controlled, and the computation complexity increases. Therefore, the coding efficiency decreases.

To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

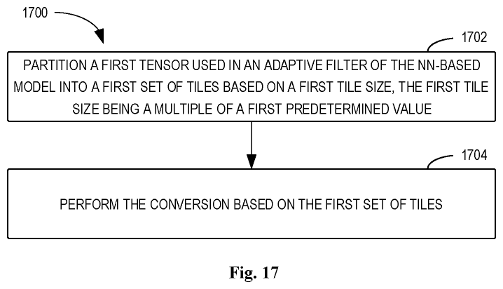

FIG. 17 illustrates a flowchart of a method 1700 for visual data processing in accordance with some embodiments of the present disclosure. The method 1700 may be implemented during a conversion between the visual data and a bitstream of the visual data with a neural network (NN)-based model. As used herein, an NN-based model may be a model based on neural network technologies. For example, an NN-based model may specify sequence of neural network modules (also called architecture) and model parameters. The neural network module may comprise a set of neural network layers. Each neural network layer specifies a tensor operation which receives and outputs tensor, and each layer has trainable parameters. It should be understood that the possible implementations of the NN-based model described here are merely illustrative and therefore should not be construed as limiting the present disclosure in any way.

As shown in FIG. 17, the method 1700 starts at 1702, where a first tensor used in an adaptive filter of the NN-based model is partitioned into a first set of tiles based on a first tile size. The first tile size is a multiple of a first predetermined value. For example, the first tensor may be a luma reconstructed tensor, an input tensor for the adaptive filter, or the like. The first tile size may comprise a width of a tile and/or a height of a tile. By way of example rather than limitation, the first predetermined value is 32, 64, or the like. For example, both the width and the height of the first tile size shall be a multiple of 64. It should be understood that the above examples are described merely for purpose of description. The scope of the present disclosure is not limited in this respect. In addition, the adaptive filter may be an adaptive up-sampler, an adaptive linear filter, or the like.

In some embodiments, boundaries of each of the first set of tiles may be determined based on the first predetermined value. For example, in a case where the first predetermine value is 64, the positions of boundaries of each tile with an index tileIdx=0 . . . cand[X][1] are calculated as follows:

$$lowH = round ( cand [ X ] [ 1 + tileIdx ] [ 0 ] \cdot \frac{H + 63}{64} ) \cdot 32 ,$$

$$upperH = min ( round ( cand [ X ] [ 1 + tileIdx ] [ 1 ] \cdot ( H + 63 ) / 64 ) \cdot 32 , \frac{H + 1}{2} ) ,$$

$$lowW = round ( cand [ X ] [ 1 + tileIdx [ 2 ] \cdot ( W + 63 ) / 64 ) \cdot 32 ,$$

$$upperW = min ( round ( cand [ X ] [ 1 + tileIdx [ 3 ] \cdot ( W + 63 ) / 64 ) \cdot 32 , \frac{W + 1}{2} ) ,$$

where lowH represents a lower boundary in a vertical direction, upperH represents a upper boundary in the vertical direction, lowW represents a lower boundary in a horizontal direction, upperW represents a upper boundary in the horizontal direction, a value of cand[X][1] is defined in the table in section 3.1.2, H represents a height of the first tensor, and W represents a width of the first tensor.

Alternatively, a floor( ) function may be employed for determining the positions of the boundaries as follows:

$$lowH = round ( cand [ X ] [ 1 + tileIdx ] [ 0 ] \cdot floor ( \frac{H + 63}{64} ) ) \cdot 32 ,$$

$$upperH = min ( round ( cand [ X ] [ 1 + tileIdx ] [ 1 ] \cdot floor ( \frac{H + 63}{64} ) ) \cdot 32 , floor ( \frac{H + 1}{2} ) ) ,$$

$$lowW = round ( cand [ X ] [ 1 + tileIdx [ 2 ] \cdot floor ( \frac{W + 63}{64} ) ) \cdot 32 ,$$

$$upperW = min ( round ( cand [ X ] [ 1 + tileIdx [ 3 ] \cdot floor ( \frac{W + 63}{64} ) ) \cdot 32 , floor ( \frac{W + 1}{2} ) ) .$$

It should be noted that boundaries of each of the first set of tiles may be determined based on the first predetermined value in any other suitable manner. The scope of the present disclosure is not limited in this respect.

It should be understood that only the most of the first set of tiles can be ensured to have the first tile size. For a tile(s) located at the boundary of the first tensor, its size may be different from the first tile size dependent on the original size of the first tensor. For example, if a size of the input tensor is a multiple of the first predetermined value, then each of the first set of tiles may have the first tile size.

At 1704, the conversion is performed based on the first set of tiles. In some embodiments, the conversion may include encoding the visual data into the bitstream. Additionally or alternatively, the conversion may include decoding the visual data from the bitstream. It should be understood that the above illustrations are described merely for purpose of description. The scope of the present disclosure is not limited in this respect.

In view of the above, the first tensor used in an adaptive filter of the NN-based model is partitioned into a first set of tiles based on a first tile size, and the first tile size is a multiple of a first predetermined value. Compared with the conventional solution where the size of the tile is not limited, the proposed method can advantageously ensure that the size of most of tiles is a multiple of a predetermined value. Thereby, the coding efficiency can be improved.

In some embodiments, a second tensor used in a non-linear filter of the NN-based model may be partitioned into a second set of tiles based on a second tile size, and the second tile size may be a multiple of a second predetermined value. For example, the second tensor may comprise an input tensor for the non-linear filter, or the like. The second tile size may comprise a width of a tile and/or a height of a tile. By way of example rather than limitation, the second predetermined value is 32, 64, or the like. In addition, the non-linear filter may be a non-linear chroma enhancement filter or the like.

In some embodiments, a size of a weight tensor for at least one of the second set of tiles may be indicated in the bitstream and may be a multiple of the second predetermined value. For example, the size of the weight tensor may comprise a width of the weight tensor and/or a heigh of the weight tensor. By way of example rather than limitation, a first syntax element (e.g., denoted as nonlinearH or nonlinear_height) may indicate a height of the weight tensor of the nonlinear filtering process, and a value of this first syntax element shall be a multiple of the second predetermined value, such as 64 or the like. Additionally or alternatively, a second syntax element (e.g., denoted as nonlinearW or nonlinear_width) may indicated a width of the weight tensor of the nonlinear filtering process, and a value of this second syntax element shall be a multiple of the second predetermined value, such as 64 or the like.

In some embodiments, the adaptive filter may be integerized. For example, all operations of the adaptive filter may be integer operations, and all values involved in the adaptive filter may be integer values. Additionally or alternatively, the non-linear filter may be integerized. For example, all operations of a non-linear filter of the NN-based model may be integer operations, and all values involved in the non-linear filter may be integer values.

In some embodiments, a weight of a convolution operation in the adaptive filter and/or the non-linear filter may be indicated in the bitstream through an integer value with a bias. For example, the weight may be determined by applying a bias shift function on the integer value and the bias. By way of example rather than limitation, an output of the bias shift function may be equal to (A−(2^{wP}−1)/2), where A represents the integer value and wP represents the bias (a.k.a., bit-depth). The bias wP may be an integer between 1 and 32. It should be noted that the bias shift function may also be referred to as a deinteger function.

In some embodiments, an offset item to be subtracted from an input of the adaptive filter may be quantized. By way of example rather than limitation, the offset item may be scaled as follows:

$${B}_{1} [ 2 ] ≪ ( I\_bit - B\_bit ) ,$$

where B₁[2] represents the offset item, I_bit represents the number of bits of the input of the adaptive filter, and B_bit represents the number of bits that are used to store elements of the offset item. By way of example rather than limitation, I_bit may be 16, and B_bit may be 15. It should be understood that the specific values recited herein are intended to be exemplary rather than limiting the scope of the present disclosure.

In some embodiments, the adaptive filter and/or the non-linear filter may comprise a quantized convolution operation. For example, the quantized convolution operation may be used to replace the original convolution operation comprised in the adaptive filter and/or the non-linear filter. The quantized convolution operation has been described in detail in above section 2.8.1. By way of example, a value of a clipping parameter d for the quantized convolution operation may be equal to 2<<(I_bits−1), where I_bits represents the number of bits of an input of the quantized convolution operation. In addition, or alternatively, a value of a de-scaling shift parameter p for the quantized convolution operation may be equal to qw_bit−w_bit, where qw_bit represents the number of bits of a quantized model parameter, and w_bit represents the number of bits of an unquantized model parameter. For example, w_bit may be an integer between 1 and 32, and/or qw_bit may be an integer between 1 and 32. In one example embodiment, w_bit may be 2, qw_bit may be 11, and thus p may be 9.

In some embodiments, an offset item to be subtracted from an input of the adaptive filter may be scaled as follows:

$${B}_{1} [ 2 ] ≪ ( I\_bit - B\_bit + qw\_bit - w\_bit ) ,$$

where B₁[2] represents the offset item, I_bit represents the number of bits of the input of the adaptive filter, and B_bit represents the number of bits that are used to store elements of the offset item, qw_bit represents the number of bits of a quantized model parameter, and w_bit represents the number of bits of an unquantized model parameter. By way of example rather than limitation, I_bit may be 16, B_bit may be 15, qw_bit may be 11 and w_bit may be 2. In this case, B₁[2] will be scaled to B₁[2]<<10.

In some embodiments, a parameter update process for the adaptive filter may be integerized. In one example embodiment, each element of a discrete cosine transform (DCT) tensor may be an integer. For example, as described above, the dct_{if} tensor may be set as dct_{if}=[−32., −224., 288., −32.].

In some embodiments, the number of tiles comprised in at least one candidate partitioning pattern may be larger than 6. By way of example rather than limitation, the number of tiles comprised in at least one candidate partitioning pattern may be 8, 9, 10, 16, or the like. In one example, the number of tiles comprised in at least one candidate partitioning pattern may be 8. In this case, a set of possible coordinates of tile candidates may be [[0, 0.25, 0, 0.5], [0.25, 0.5, 0, 0.5], [0.5, 0.75, 0, 0.5], [0.75, 1, 0, 0.5], [0, 0.25, 0.5, 1], [0.25, 0.5, 0.5, 1], [0.5, 0.75, 0.5, 1], [0.75, 1, 0.5, 0.25]]. Furthermore, another set of possible coordinates of tile candidates may be [[0, 0.5, 0, 0.25], [0, 0.5, 0.25, 0.5], [0, 0.5, 0.5, 0.75], [0, 0.5, 0.75, 1], [0.5, 1, 0, 0.25], [0.5, 1, 0.25, 0.5], [0.5, 1, 0.5, 0.75], [0.5, 1, 0.75, 1]]. Possible coordinates of tile candidates for other cases are listed in above section 5 fur purpose of illustration. It should be understood that the above examples are described merely for purpose of description. The scope of the present disclosure is not limited in this respect.

In some embodiments, the bitstream may comprise a first indication indicating an index of a kernel size of the adaptive filter or a non-linear filter of the NN-based model among a set of kernel sizes. For example, this first indication may be denoted as fId. In one example embodiment, the set of kernel sizes may be predetermined and stored in a table. By way of example, the set of kernel sizes may be a subset of [(1,1), (2,2), (3,3), (4,4), (2,1), (1,2), (3,1), (1,3), (2,3), (3,2), (1,4), (4,1), (2,4), (4,2), (3,4), (4,3)].

In some embodiments, an element of the kernel size may be a 9-valued non-negative integer value, and a value of the element shall be smaller than 4 and greater 0. Alternatively, a value of an element of the kernel size shall be smaller than 16 and greater than 0. In a further embodiment, the value of the element shall be smaller than 6 and greater than 0. Alternatively, the value of the element shall be smaller than 8 and greater than 0. In some further embodiments, a value of the first indication is required to be smaller than a predetermined value, so as save the bit cost of the first indication.

In some embodiments, a rectified linear unit (ReLU) may be absent from the non-linear filter. In addition, or alternatively, a result of an initial enhancement (e.g., denoted as \hat{x}³_{UV} in FIG. 11) may be directly used as an output of the non-linear filter. Additionally or alternatively, an enhanced secondary component (e.g., denoted as \hat{x}′″_{UV} in FIG. 11) outputted from an inter channel correlation information (ICCI) filter in the NN-based model may be not inputted to the non-linear filter, and the operations related to this enhanced secondary component can be disabled in this case.

In some further embodiments, an enhanced secondary component (e.g., denoted as \hat{x}″_{UV} in FIG. 11) outputted from the adaptive filter may be not inputted to the non-linear filter. In this case, the first branch used for processing this enhanced secondary component may be removed, and the resulting structure of the non-linear filter is shown in FIG. 12.

In some embodiments, if picture format upsampling is needed and an enhancement filter extension (EFE) luma-aided upsampling process is disabled, an adaptive up-sampler with fixed weights may be applied. For example, the fixed weights may be predetermined and absent from the bitstream, i.e., not signaled in the bitstream. In addition, the adaptive up-sampler may comprise a quantized adaptive convolution process as described in detail above.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a bitstream of visual data which is generated by a method performed by an apparatus for visual data processing. The method comprises: partitioning a first tensor used in an adaptive filter of a neural network (NN)-based model into a first set of tiles based on a first tile size, the first tile size being a multiple of a first predetermined value; and generating the bitstream with the NN-based model based on the first set of tiles.

According to still further embodiments of the present disclosure, a method for storing bitstream of visual data is provided. The method comprises: partitioning a first tensor used in an adaptive filter of a neural network (NN)-based model into a first set of tiles based on a first tile size, the first tile size being a multiple of a first predetermined value; generating the bitstream with the NN-based model based on the first set of tiles; and storing the bitstream in a non-transitory computer-readable recording medium.

Implementations of the present disclosure can be described in view of the following clauses, the features of which can be combined in any reasonable manner.
Clause 1. A method for visual data processing, comprising: partitioning, for a conversion between visual data and a bitstream of the visual data with a neural network (NN)-based model, a first tensor used in an adaptive filter of the NN-based model into a first set of tiles based on a first tile size, the first tile size being a multiple of a first predetermined value; and performing the conversion based on the first set of tiles.
Clause 2. The method of clause 1, wherein the first tensor comprises a luma reconstructed tensor or an input tensor for the adaptive filter.
Clause 3. The method of any of clauses 1-2, wherein boundaries of each of the first set of tiles is determined based on the first predetermined value.
Clause 4. The method of any of clauses 1-3, wherein the first tile size comprises at least one of the following: a width of a tile, or a height of a tile.
Clause 5. The method of any of clauses 1-4, wherein if a size of the input tensor is a multiple of the first predetermined value, each of the first set of tiles has the first tile size.
Clause 6. The method of any of clauses 1-5, wherein the first predetermined value is 64.
Clause 7. The method of any of clauses 1-6, wherein the adaptive filter is an adaptive up-sampler.
Clause 8. The method of any of clauses 1-7, wherein a second tensor used in a non-linear filter of the NN-based model is partitioned into a second set of tiles based on a second tile size, and the second tile size is a multiple of a second predetermined value.
Clause 9. The method of clause 8, wherein the second tensor comprises an input tensor for the non-linear filter.
Clause 10. The method of any of clauses 8-9, wherein the second tile size comprises at least one of the following: a width of a tile, or a height of a tile.
Clause 11. The method of any of clauses 8-10, wherein a size of a weight tensor for at least one of the second set of tiles is indicated in the bitstream and is a multiple of the second predetermined value.
Clause 12. The method of clause 11, wherein the size of the weight tensor comprises at least one of the following: a width of the weight tensor, or a heigh of the weight tensor.
Clause 13. The method of any of clauses 8-12, wherein the second predetermined value is 64.
Clause 14. The method of any of clauses 8-13, wherein the non-linear filter is a non-linear chroma enhancement filter.
Clause 15. The method of any of clauses 1-14, wherein all operations of the adaptive filter are integer operations, and all values involved in the adaptive filter are integer values, and/or wherein all operations of a non-linear filter of the NN-based model are integer operations, and all values involved in the non-linear filter are integer values.
Clause 16. The method of clause 15, wherein a weight of a convolution operation in the adaptive filter and/or the non-linear filter is indicated in the bitstream through an integer value with a bias.
Clause 17. The method of clause 16, wherein the weight is determined by applying a bias shift function on the integer value and the bias.
Clause 18. The method of clause 17, wherein an output of the bias shift function is equal to (A−(2^{wP}−1)/2), wherein A represents the integer value and wP represents the bias.
Clause 19. The method of clause 18, wherein the bias wP is an integer between 1 and 32.
Clause 20. The method of any of clauses 15-19, wherein an offset item to be subtracted from an input of the adaptive filter is quantized.
Clause 21. The method of clause 20, wherein the offset item is scaled as follows:

$${B}_{1} [ 2 ] ≪ ( I\_bit - B\_bit ) ,$$

wherein B₁[2] represents the offset item, I_bit represents the number of bits of the input of the adaptive filter, and B_bit represents the number of bits that are used to store elements of the offset item.
Clause 22. The method of clause 21, wherein I_bit is 16, and B_bit is 15.
Clause 23. The method of any of clauses 15-22, wherein the adaptive filter and/or the non-linear filter comprises a quantized convolution operation.
Clause 24. The method of clause 23, wherein a value of a clipping parameter d for the quantized convolution operation is equal to 2<<(I_bits−1), wherein I_bits represents the number of bits of an input of the quantized convolution operation.
Clause 25. The method of any of clauses 23-24, wherein a value of a de-scaling shift parameter p for the quantized convolution operation is equal to qw_bit−w_bit, wherein qw_bit represents the number of bits of a quantized model parameter, and w_bit represents the number of bits of an unquantized model parameter.
Clause 26. The method of clause 25, wherein w_bit is an integer between 1 and 32, or qw_bit is an integer between 1 and 32.
Clause 27. The method of any of clauses 25-26, wherein w_bit is 2, qw_bit is 11, and p is 9.
Clause 28. The method of any of clauses 23-27, wherein an offset item to be subtracted from an input of the adaptive filter is scaled as follows:

$${B}_{1} [ 2 ] ≪ ( I\_bit - B\_bit + qw\_bit - w\_bit ) ,$$

wherein B₁[2] represents the offset item, I_bit represents the number of bits of the input of the adaptive filter, and B_bit represents the number of bits that are used to store elements of the offset item, qw_bit represents the number of bits of a quantized model parameter, and w_bit represents the number of bits of an unquantized model parameter.
Clause 29. The method of clause 28, wherein I_bit is 16, B_bit is 15, qw_bit is 11 and w_bit is 2.
Clause 30. The method of any of clauses 15-29, wherein a parameter update process for the adaptive filter is integerized.
Clause 31. The method of clause 30, wherein each element of a discrete cosine transform (DCT) tensor is an integer.
Clause 32. The method of any of clauses 1-31, wherein the number of tiles comprised in at least one candidate partitioning pattern is larger than 6.
Clause 33. The method of clause 32, wherein the number of tiles comprised in at least one candidate partitioning pattern is 8, 9, 10, or 16.
Clause 34. The method of any of clauses 1-33, wherein the bitstream comprises a first indication indicating an index of a kernel size of the adaptive filter or a non-linear filter of the NN-based model among a set of kernel sizes.
Clause 35. The method of clause 34, wherein the set of kernel sizes are predetermined and stored in a table.
Clause 36. The method of clause 35, wherein the set of kernel sizes is a subset of [(1,1), (2,2), (3,3), (4,4), (2,1), (1,2), (3,1), (1,3), (2,3), (3,2), (1,4), (4,1), (2,4), (4,2), (3,4), (4,3)].
Clause 37. The method of any of clauses 34-36, wherein an element of the kernel size is a 9-valued non-negative integer value, and a value of the element is smaller than 4 and greater 0.
Clause 38. The method of any of clauses 34-36, wherein a value of an element of the kernel size is smaller than 16 and greater than 0, or the value of the element is smaller than 6 and greater than 0, or the value of the element is smaller than 8 and greater than 0.
Clause 39. The method of any of clauses 34-38, wherein a value of the first indication is smaller than a predetermined value.
Clause 40. The method of any of clauses 8-39, wherein a rectified linear unit (ReLU) is absent from the non-linear filter.
Clause 41. The method of any of clauses 8-40, wherein a result of an initial enhancement is directly used as an output of the non-linear filter.
Clause 42. The method of any of clauses 8-41, wherein an enhanced secondary component outputted from an inter channel correlation information (ICCI) filter in the NN-based model is not inputted to the non-linear filter.
Clause 43. The method of any of clauses 8-42, wherein an enhanced secondary component outputted from the adaptive filter is not inputted to the non-linear filter.
Clause 44. The method of any of clauses 1-43, wherein if picture format upsampling is needed and an enhancement filter extension (EFE) luma-aided upsampling process is disabled, an adaptive up-sampler with fixed weights is applied.
Clause 45. The method of clause 44, wherein the fixed weights are predetermined and absent from the bitstream.
Clause 46. The method of any of clauses 44-45, wherein the adaptive up-sampler comprises a quantized adaptive convolution process.
Clause 47. The method of any of clauses 1-46, wherein the visual data comprise a video, a picture of the video, or an image.
Clause 48. The method of any of clauses 1-47, wherein the conversion includes encoding the visual data into the bitstream.
Clause 49. The method of any of clauses 1-47, wherein the conversion includes decoding the visual data from the bitstream.
Clause 50. An apparatus for visual data processing comprising a processor and a non-transitory memory with instructions thereon, wherein the instructions upon execution by the processor, cause the processor to perform a method in accordance with any of clauses 1-49.
Clause 51. A non-transitory computer-readable storage medium storing instructions that cause a processor to perform a method in accordance with any of clauses 1-49.
Clause 52. A non-transitory computer-readable recording medium storing a bitstream of visual data which is generated by a method performed by an apparatus for visual data processing, wherein the method comprises: partitioning a first tensor used in an adaptive filter of a neural network (NN)-based model into a first set of tiles based on a first tile size, the first tile size being a multiple of a first predetermined value; and generating the bitstream with the NN-based model based on the first set of tiles.
Clause 53. A method for storing a bitstream of visual data, comprising: partitioning a first tensor used in an adaptive filter of a neural network (NN)-based model into a first set of tiles based on a first tile size, the first tile size being a multiple of a first predetermined value; generating the bitstream with the NN-based model based on the first set of tiles; and storing the bitstream in a non-transitory computer-readable recording medium.

### Example Device

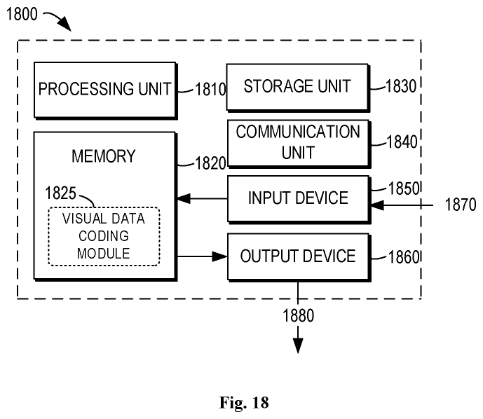

FIG. 18 illustrates a block diagram of a computing device 1800 in which various embodiments of the present disclosure can be implemented. The computing device 1800 may be implemented as or included in the source device 110 (or the visual data encoder 114) or the destination device 120 (or the visual data decoder 124).

It would be appreciated that the computing device 1800 shown in FIG. 18 is merely for purpose of illustration, without suggesting any limitation to the functions and scopes of the embodiments of the present disclosure in any manner.

As shown in FIG. 18, the computing device 1800 includes a general-purpose computing device 1800. The computing device 1800 may at least comprise one or more processors or processing units 1810, a memory 1820, a storage unit 1830, one or more communication units 1840, one or more input devices 1850, and one or more output devices 1860.

In some embodiments, the computing device 1800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1800 can support any type of interface to a user (such as “wearable” circuitry and the like).

The processing unit 1810 may be a physical or virtual processor and can implement various processes based on programs stored in the memory 1820. In a multi-processor system, multiple processing units execute computer executable instructions in parallel so as to improve the parallel processing capability of the computing device 1800. The processing unit 1810 may also be referred to as a central processing unit (CPU), a microprocessor, a controller or a microcontroller.

The computing device 1800 typically includes various computer storage medium. Such medium can be any medium accessible by the computing device 1800, including, but not limited to, volatile and non-volatile medium, or detachable and non-detachable medium. The memory 1820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1830 may be any detachable or non-detachable medium and may include a machine-readable medium such as a memory, flash memory drive, magnetic disk or another other media, which can be used for storing information and/or visual data and can be accessed in the computing device 1800.

The computing device 1800 may further include additional detachable/non-detachable, volatile/non-volatile memory medium. Although not shown in FIG. 18, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 1840 communicates with a further computing device via the communication medium. In addition, the functions of the components in the computing device 1800 can be implemented by a single computing cluster or multiple computing machines that can communicate via communication connections. Therefore, the computing device 1800 can operate in a networked environment using a logical connection with one or more other servers, networked personal computers (PCs) or further general network nodes.

The input device 1850 may be one or more of a variety of input devices, such as a mouse, keyboard, tracking ball, voice-input device, and the like. The output device 1860 may be one or more of a variety of output devices, such as a display, loudspeaker, printer, and the like. By means of the communication unit 1840, the computing device 1800 can further communicate with one or more external devices (not shown) such as the storage devices and display device, with one or more devices enabling the user to interact with the computing device 1800, or any devices (such as a network card, a modem and the like) enabling the computing device 1800 to communicate with one or more other computing devices, if required. Such communication can be performed via input/output (I/O) interfaces (not shown).

In some embodiments, instead of being integrated in a single device, some or all components of the computing device 1800 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1800 may be used to implement visual data encoding/decoding in embodiments of the present disclosure. The memory 1820 may include one or more visual data coding modules 1825 having one or more program instructions. These modules are accessible and executable by the processing unit 1810 to perform the functionalities of the various embodiments described herein.

In the example embodiments of performing visual data encoding, the input device 1850 may receive visual data as an input 1870 to be encoded. The visual data may be processed, for example, by the visual data coding module 1825, to generate an encoded bitstream. The encoded bitstream may be provided via the output device 1860 as an output 1880.

In the example embodiments of performing visual data decoding, the input device 1850 may receive an encoded bitstream as the input 1870. The encoded bitstream may be processed, for example, by the visual data coding module 1825, to generate decoded visual data. The decoded visual data may be provided via the output device 1860 as the output 1880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
partitioning, for a conversion between visual data and a bitstream of the visual data with a neural network (NN)-based model, a first tensor used in an adaptive filter of the NN-based model into a first set of tiles based on a first tile size, the first tile size being a multiple of a first predetermined value; and
performing the conversion based on the first set of tiles.

2. The method of claim 1, wherein the first tensor comprises a luma reconstructed tensor or an input tensor for the adaptive filter.

3. The method of claim 1, wherein boundaries of each of the first set of tiles is determined based on the first predetermined value.

4. The method of claim 1, wherein the first tile size comprises at least one of the following:
a width of a tile, or
a height of a tile.

5. The method of claim 1, wherein the first predetermined value is 64.

6. The method of claim 1, wherein the adaptive filter is an adaptive up-sampler.

7. The method of claim 1, wherein a second tensor used in a non-linear filter of the NN-based model is partitioned into a second set of tiles based on a second tile size, and the second tile size is a multiple of a second predetermined value.

8. The method of claim 7, wherein the second tensor comprises an input tensor for the non-linear filter.

9. The method of claim 7, wherein the second tile size comprises at least one of the following:
a width of a tile, or
a height of a tile.

10. The method of claim 7, wherein a size of a weight tensor for at least one of the second set of tiles is indicated in the bitstream and is a multiple of the second predetermined value.

11. The method of claim 10, wherein the size of the weight tensor comprises at least one of the following:
a width of the weight tensor, or
a heigh of the weight tensor.

12. The method of claim 7, wherein the second predetermined value is 64.

13. The method of claim 7, wherein the non-linear filter is a non-linear chroma enhancement filter.

14. The method of claim 1, wherein all operations of the adaptive filter are integer operations, and all values involved in the adaptive filter are integer values, or
wherein all operations of a non-linear filter of the NN-based model are integer operations, and all values involved in the non-linear filter are integer values; or
wherein the number of tiles comprised in at least one candidate partitioning pattern is larger than 6; or
wherein the bitstream comprises a first indication indicating an index of a kernel size of the adaptive filter or a non-linear filter of the NN-based model among a set of kernel sizes.

15. The method of claim 1, wherein the visual data comprise a video, a picture of the video, or an image.

16. The method of claim 1, wherein the conversion includes encoding the visual data into the bitstream.

17. The method of claim 1, wherein the conversion includes decoding the visual data from the bitstream.

18. The method of claim 1, wherein the conversion comprises: generating the bitstream from the visual data, and
the method further comprises: storing the bitstream in a non-transitory computer-readable recording medium.

19. An apparatus for visual data processing comprising a processor and a non-transitory memory with instructions thereon, wherein the instructions upon execution by the processor, cause the processor to perform operations comprising:
partitioning, for a conversion between visual data and a bitstream of the visual data with a neural network (NN)-based model, a first tensor used in an adaptive filter of the NN-based model into a first set of tiles based on a first tile size, the first tile size being a multiple of a first predetermined value; and
performing the conversion based on the first set of tiles.

20. A non-transitory computer-readable storage medium storing instructions that cause a processor to perform operations comprising:
partitioning, for a conversion between visual data and a bitstream of the visual data with a neural network (NN)-based model, a first tensor used in an adaptive filter of the NN-based model into a first set of tiles based on a first tile size, the first tile size being a multiple of a first predetermined value; and
performing the conversion based on the first set of tiles.
